(19) United States
(12) Patent Application Publication
(10) Pub. No.: US 2024/0089761 A1
(43) Pub. Date: Mar. 14, 2024

(54) ADVERTISEMENT OF WIRELESS CONNECTION QUALITY ESTIMATION

(71) Applicant: QUALCOMM Incorporated, San Diego, CA (US)

(72) Inventor: Rajeev Kumar, San Diego, CA (US)

(21) Appl. No.: 17/940,892

(22) Filed: Sep. 8, 2022

(51) Int. Cl. H04W 24/08

(52) U.S. Cl. CPC H04W 24/08

(57) ABSTRACT

Methods, systems, and devices for wireless communication are described in which an access point (AP) may advertise Internet connection quality information in a beacon transmission or probe request. The AP may measure one or more metrics associated with Internet access, and provide an indication of the metrics in an information element transmitted to one or more stations (STAs). In some examples, an Internet connection quality information element may include one or more fields associated with connection metrics, such as Internet reachability, link latency, available uplink bandwidth, and available downlink bandwidth. STAs may look for the Internet connection quality information element and may decide whether to connect to an AP based on the indicated metrics.

### TECHNICAL FIELD

The following relates to wireless communication, including advertisement of wireless connection quality estimation.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network, for example a WLAN, such as a Wi-Fi (for example, Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

In some cases, a STA may have one or more applications that use Internet-hosted services, and a high-quality Internet connection (for example, a connection with sufficient bandwidth to support expected Internet traffic) is desirable. However, in order to determine the quality of a connection between an AP and the Internet, the STA must connect to the AP and then gather relevant metrics (for example, latency and available bandwidth). In cases in which the AP does not have the connection with the Internet of sufficient quality (for example, due to high congestion, transient backhaul issues, AP overloading, other clients consuming available backhaul), such procedures may result in the STA making a connection with the AP that is unproductive, and the STA having to then connect to another AP and perform a same or similar process. Such connections and processes may reduce network efficiency due to resources consumed to make the connections and gather the connection metrics multiple times, among other aspects.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a wireless station. The method includes receiving a first message from a first wireless access point, the first message including a beacon message or probe response that indicates a first network connection quality associated with one or more metrics associated with Internet access via the first wireless access point and transmitting an association request to the first wireless access point based on the first network connection quality and one or more Internet connection quality criteria.

Another innovative aspect of the subject matter described in this disclosure can be implemented in an apparatus for wireless communication at a wireless station. The apparatus includes a processor, memory coupled with the processor, and instructions stored in the memory. The instructions executable by the processor to cause the apparatus to receive a first message from a first wireless access point, the first message including a beacon message or probe response that indicates a first network connection quality associated with one or more metrics associated with Internet access via the first wireless access point and transmit an association request to the first wireless access point based on the first network connection quality and one or more Internet connection quality criteria.

Another innovative aspect of the subject matter described in this disclosure can be implemented in another apparatus for wireless communication at a wireless station. The apparatus includes means for receiving a first message from a first wireless access point, the first message including a beacon message or probe response that indicates a first network connection quality associated with one or more metrics associated with Internet access via the first wireless access point and means for transmitting an association request to the first wireless access point based on the first network connection quality and one or more Internet connection quality criteria.

Another innovative aspect of the subject matter described in this disclosure can be implemented in a non-transitory computer-readable medium storing code for wireless communication at a wireless station. The code includes instructions executable by a processor to receive a first message from a first wireless access point, the first message including a beacon message or probe response that indicates a first network connection quality associated with one or more metrics associated with Internet access via the first wireless access point and transmit an association request to the first wireless access point based on the first network connection quality and one or more Internet connection quality criteria.

Another innovative aspect of the subject matter described in this disclosure can be implemented in a method for wireless communication at a wireless access point. The method includes transmitting a first message to one or more wireless stations, the first message including a beacon message or probe response, and the first message including a network connection quality indication associated with one or more metrics associated with Internet access via the wireless access point and receiving, from at least a first wireless station of the one or more wireless stations, an association request for Internet access via the wireless access point.

Another innovative aspect of the subject matter described in this disclosure can be implemented in an apparatus for wireless communication at a wireless access point. The apparatus includes a processor, memory coupled with the processor, and instructions stored in the memory. The instructions may be executable by the processor to cause the apparatus to transmit a first message to one or more wireless stations, the first message including a beacon message or probe response, and the first message including a network connection quality indication associated with one or more metrics associated with Internet access via the wireless access point and receive, from at least a first wireless station of the one or more wireless stations, an association request for Internet access via the wireless access point.

Another innovative aspect of the subject matter described in this disclosure can be implemented another apparatus for wireless communication at a wireless access point. The apparatus includes means for transmitting a first message to one or more wireless stations, the first message including a beacon message or probe response, and the first message including a network connection quality indication associated with one or more metrics associated with Internet access via the wireless access point and means for receiving, from at least a first wireless station of the one or more wireless stations, an association request for Internet access via the wireless access point.

Another innovative aspect of the subject matter described in this disclosure can be implemented in a non-transitory computer-readable medium storing code for wireless communication at a wireless access point. The code includes instructions executable by a processor to transmit a first message to one or more wireless stations, the first message including a beacon message or probe response, and the first message including a network connection quality indication associated with one or more metrics associated with Internet access via the wireless access point and receive, from at least a first wireless station of the one or more wireless stations, an association request for Internet access via the wireless access point.

### BRIEF DESCRIPTION OF THE DRAWINGS

FIGS. 1-4 each illustrate an example of a wireless local area network (WLAN) that supports advertisement of wireless connection quality estimation in accordance with aspects of the present disclosure.

FIG. 5 illustrates an example of a process flow that supports advertisement of wireless connection quality estimation in accordance with one or more aspects of the present disclosure.

FIGS. 6, 7A, and 7B show block diagrams of devices that support advertisement of wireless connection quality estimation in accordance with one or more aspects of the present disclosure.

FIGS. 8 and 9 show block diagrams of devices that support advertisement of wireless connection quality estimation in accordance with one or more aspects of the present disclosure.

FIG. 10 shows a block diagram of a communications manager that supports advertisement of wireless connection quality estimation in accordance with one or more aspects of the present disclosure.

FIG. 11 shows a diagram of a system including a device that supports advertisement of wireless connection quality estimation in accordance with one or more aspects of the present disclosure.

FIGS. 12 and 13 show block diagrams of devices that support advertisement of wireless connection quality estimation in accordance with one or more aspects of the present disclosure.

FIG. 14 shows a block diagram of a communications manager that supports advertisement of wireless connection quality estimation in accordance with one or more aspects of the present disclosure.

FIG. 15 shows a diagram of a system including a device that supports advertisement of wireless connection quality estimation in accordance with one or more aspects of the present disclosure.

FIGS. 16 through 22 show flowcharts illustrating methods that support advertisement of wireless connection quality estimation in accordance with one or more aspects of the present disclosure.

### DETAILED DESCRIPTION

Many applications that operating at a wireless station (STA) may use Internet-hosted services, and a reliable Internet connection may be needed to provide such services. In some systems, in order to evaluate a quality of the link between an access point (AP) and the Internet, STAs (for example, client devices) may connect to the AP and gather statistics related to a quality of the associated Internet connection, among other aspects. This may result in the STAs making a connection, such as a Wi-Fi connection, that is unproductive and wasteful in some cases. For example, in examples in which the AP has relatively high traffic and/or a relatively high quantity of served STAs, congestion may result in a poor Internet connection associated with the AP. Further, an Internet connection of the AP may be impacted by other factors, such as transient-backhaul issues, AP overloading, and/or other client traffic consuming available backhaul, among others. In order to evaluate an Internet link quality, the STAs may implement their own Internet reachability test and use network quality metrics to help drive roaming or reconnection decisions. However, these tests rely on the STAs first connecting to an AP and then performing testing with the AP. This can increase access latency that may result in poor user experience and, in some cases, may result in a user disabling Wi-Fi and instead using a different (for example, cellular) connection, among other issues.

Various aspects generally relate to techniques for an advertisement of wireless connection quality estimation, and more specifically, for transmission of Internet connection quality information in a signal, such as in a beacon or a probe request. For example, an Internet connection quality information element (IE) may be transmitted (for example, broadcast) with one or more beacon frames or probe requests from an AP. The AP may measure one or more metrics associated with Internet access, and provide an indication of the metrics in the IE to STAs. In some examples, an Internet connection quality IE may include one or more fields, such as an Internet reachability field that may provide a binary indication of Internet reachability for the AP, an Internet link latency field, an uplink bandwidth field that indicates available uplink bandwidth, and/or a downlink bandwidth field that indicates available downlink bandwidth, among other examples. The STAs may detect and/or determine the Internet connection quality IE, and decide whether to connect to an AP based on the metrics related to the Internet connection quality IE. In some examples, a STA may make steering decisions between different APs, or between a cellular connection and AP connection, based on deciding whether to connect to the AP. Such decisions may be made without connecting to the AP, and without performing separate testing for one or more different APs. In some examples, the proposed metrics can be combined with one or more metrics associated with a wireless local area network—such as quality of service (QoS) enhanced basic service set (QBSS) load IE metrics that provide local network load metrics for a BSS—to provide additional information that may be used by the STAs to select an AP for network access.

Particular aspects of the subject matter described herein may be implemented to realize one or more of the following potential advantages. The techniques employed by the described AP and STA may enable AP selection based on connection quality advertised by the AP, which may reduce access latency. In some implementations, selection of the AP based on the advertised Internet connection quality may enhance STA operation through a selection of the AP having a suitable connection quality, and avoidance of a different AP that cannot reach the Internet or has poor connection quality. In some implementations, the STA may use the advertised connection quality to avoid roaming to an AP that has a relatively poor connection or no Internet connection. In some implementations, operations performed by the AP and the STA may support improvements to power consumption, connection latency, reliability for communications, and throughput for the AP and the STA based on determining that the advertised Internet connection quality of the AP is sufficient for the STA (for example, based on a connection with the AP having sufficient Internet connection quality to support expected Internet traffic for the STA).

Aspects of the disclosure are initially described in the context of wireless local area networks (WLANs). Aspects of the disclosure are also described in the context of channel hopping schemes and process flows. Aspects of the disclosure are further illustrated by and described with reference to apparatus diagrams, system diagrams, and flowcharts that relate to managing hopping TWTs for wireless networks

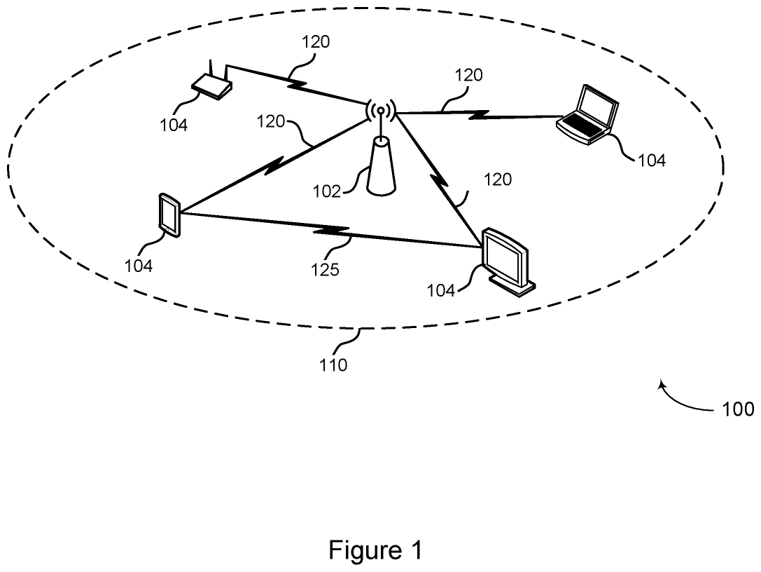

FIG. 1 illustrates a WLAN 100 (also known as a Wi-Fi network) configured in accordance with various aspects of the present disclosure. The WLAN 100 may include an AP 102 and multiple associated STAs 104, which may represent devices such as mobile stations, personal digital assistant (PDAs), other handheld devices, netbooks, notebook computers, tablet computers, laptops, display devices (for example, TVs, computer monitors), or printers. The AP 102 and the associated stations 104 may represent a BSS or an ESS. The various STAs 104 in the network are able to communicate with one another through the AP 102. Also shown is a coverage area 110 of the AP 102, which may represent a BSA of the WLAN 100. An extended network station (not shown) associated with the WLAN 100 may be connected to a wired or wireless distribution system that may allow multiple APs 102 to be connected in an ESS.

In the WLAN 100, a communication device (for example, an AP 102) may advertise Internet connection quality. For example, an AP 102 may transmit an Internet connection quality information element (IE) with beacon frames or probe requests. Such an AP 102 may measure one or more metrics associated with Internet access, and provide an indication of the metrics in the IE to STAs 104. A STA 104 may look for the Internet connection quality IE and may decide whether to connect to an AP 102 based on the indicated metrics and one or more connection quality criteria (for example, whether the AP 102 has Internet connectivity, one or more threshold values associated with the one or more metrics associated with Internet access, or any combination thereof). In some examples, a STA 104 may make steering decisions between different APs 102 or between a cellular connection and AP 102 connection. Such decisions may be made without connecting to an AP 102 and performing separate testing for one or more different APs 102. In some examples, the proposed metrics can be combined with one or more metrics associated with a wireless local area network, such as QBSS load IE metrics that provide local network load metrics for a BSS, to provide additional information that may be used at STAs 104 to select an AP 102 for network access.

Although not shown in FIG. 1, a STA 104 may be located in the intersection of more than one coverage area 110 and may associate with more than one AP 102. A single AP 102 and an associated set of STAs 104 may be referred to as a BSS. An ESS is a set of connected BSSs. A distribution system (not shown) may be used to connect APs 102 in an ESS. In some cases, the coverage area 110 of an AP 102 may be divided into sectors (also not shown). The WLAN 100 may include APs 102 of different types (for example, metropolitan area, home network), with varying and overlapping coverage areas 110. Two STAs 104 may also communicate directly via a direct wireless link 125 regardless of whether both STAs 104 are in the same coverage area 110. Examples of direct wireless links 120 may include Wi-Fi Direct connections, Wi-Fi Tunneled Direct Link Setup (TDLS) links, and other group connections. STAs 104 and APs 102 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax. In other implementations, peer-to-peer connections or ad hoc networks may be implemented within WLAN 100.

In some cases, a STA 104 (or an AP 102) may be detectable by a central AP 102, but not by other STAs 104 in the coverage area 110 of the central AP 102. For example, one STA 104 may be at one end of the coverage area 110 of the central AP 102 while another STA 104 may be at the other end. Thus, both STAs 104 may communicate with the AP 102, but may not receive the transmissions of the other. This may result in colliding transmissions for the two STAs 104 in a contention based environment (for example, CSMA/CA) because the STAs 104 may not refrain from transmitting on top of each other. A STA 104 whose transmissions are not identifiable, but that is within the same coverage area 110 may be known as a hidden node. CSMA/CA may be supplemented by the exchange of an RTS packet transmitted by a sending STA 104 (or AP 102) and a CTS packet transmitted by the receiving STA 104 (or AP 102). This may alert other devices within range of the sender and receiver not to transmit for the duration of the primary transmission. Thus, RTS/CTS may help mitigate a hidden node problem.

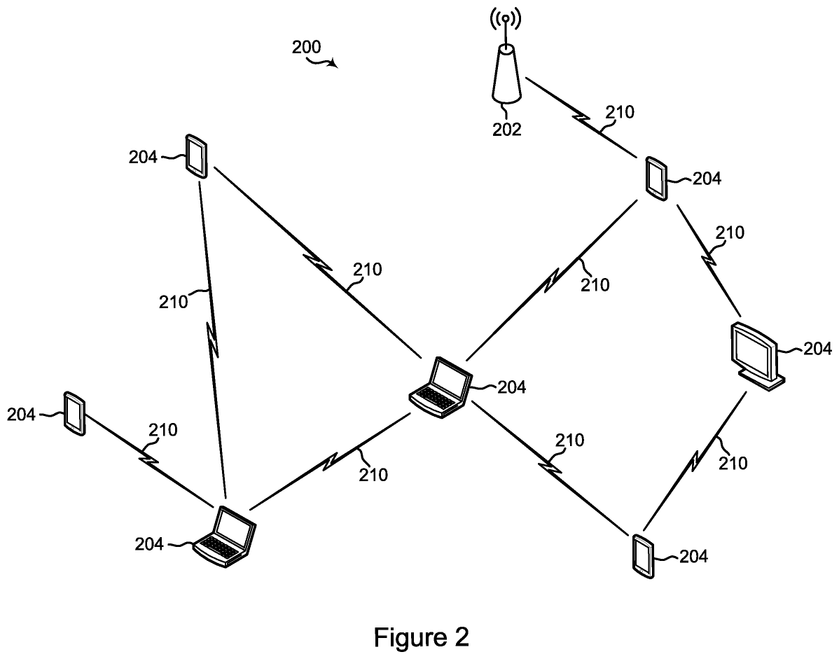

FIG. 2 illustrates an example of a WLAN 200 that supports managing hopping TWTs for wireless networks in accordance with one or more aspects of the present disclosure. According to some aspects, the WLAN 200 can be an example of a WLAN. For example, the WLAN 200 can be a network implementing at least one of the IEEE 802.11 family of standards. The WLAN 200 may include multiple STAs 204. As described above, each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The WLAN 200 is an example of a peer-to-peer (P2P), ad hoc or mesh network. STAs 204 can communicate directly with each other via P2P wireless links 210 (without the use of an intermediary AP). In some implementations, the WLAN 200 is an example of a neighbor awareness network (NAN). NANs operate in accordance with the Wi-Fi Alliance (WFA) Neighbor Awareness Networking (also referred to as NAN) standard specification. NAN-compliant STAs 204 (hereinafter also simply “NAN devices 204”) transmit and receive NAN communications (for example, in the form of Wi-Fi packets including frames conforming to an IEEE 802.11 wireless communication protocol standard such as that defined by the IEEE 802.11-2016 specification or amendments thereof including, but not limited to, 802.11ay, 802.11ax, 802.11az, 802.11ba and 802.11be) to and from one another via wireless P2P links 210 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 204 in the network automatically establish an ad-hoc network with other NAN devices 204 such that network connectivity can be maintained. Each NAN device 204 is configured to relay data for the NAN network such that various NAN devices 204 may cooperate in the distribution of data within the network. As a result, a message can be transmitted from a source NAN device to a destination NAN device by being propagated along a path, hopping from one NAN device to the next until the destination is reached.

Each NAN device 204 is configured to transmit two types of beacons: NAN discovery beacons and NAN synchronization beacons. When a NAN device 204 is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices 204 passively scan for discovery beacons from other NAN devices. When two NAN devices 204 come within a transmission range of one another, they will discover each other based on such discovery beacons. Respective master preference values determine which of the NAN devices 204 will become the master device. If a NAN cluster is not discovered, a NAN device 204 may start a new NAN cluster. When a NAN device 204 starts a NAN cluster, it assumes the master role and broadcasts a discovery beacon. Additionally, a NAN device may choose to participate in more than one NAN cluster within a NAN network.

The links between the NAN devices 204 in a NAN cluster are associated with discovery windows—the times and channel on which the NAN devices converge. At the beginning of each discovery window, one or more NAN devices 204 may transmit a NAN synchronization beacon, which is a management frame used to synchronize the timing of the NAN devices within the NAN cluster to that of the master device. The NAN devices 204 may then transmit multicast or unicast NAN service discovery frames directly to other NAN devices within the service discovery threshold and in the same NAN cluster during the discovery window. The service discovery frames indicate services supported by the respective NAN devices 204.

In some instances, NAN devices 204 may exchange service discovery frames to ascertain whether both devices support ranging operations. NAN devices 204 may perform such ranging operations (“ranging”) during the discovery windows. The ranging may involve an exchange of fine timing measurement (FTM) frames (such as those defined in IEEE 802.11-REVmc). For example, a first NAN device 204 may transmit unicast FTM requests to multiple peer NAN devices 204. The peer NAN devices 204 may then transmit responses to the first NAN device 204. The first NAN device 204 may then exchange a number of FTM frames with each of the peer NAN devices 204. The first NAN device 204 may then determine a range between itself and each of the peer devices 204 based on the FTM frames and transmit a range indication to each of the peer NAN devices 204. For example, the range indication may include a distance value or an indication as to whether a peer NAN device 204 is within a service discovery threshold (for example, 3 meters (m)) of the first NAN device 204. NAN links between NAN devices within the same NAN cluster may persist over multiple discovery windows as long as the NAN devices remain within the service discovery thresholds of one another and synchronized to the anchor master of the NAN cluster.

Some NAN devices 204 also may be configured for wireless communication with other networks such as with a Wi-Fi WLAN or a wireless (for example, cellular) wide area network (WWAN), which may, in turn, provide access to external networks including the Internet. For example, a NAN device 204 may be configured to associate and communicate, via a Wi-Fi or cellular link 212, with an AP or base station 202 of a WLAN or WWAN network, respectively. In such instances, the NAN device 204 may include software-enabled AP (SoftAP) functionality enabling the STA to operate as a Wi-Fi hotspot to provide other NAN devices 204 with access to the external networks via the associated WLAN or WWAN backhaul. Such a NAN device 204 (referred to as a NAN concurrent device) is capable of operating in both a NAN network as well as another type of wireless network, such as a Wi-Fi BSS. In some such implementations, a NAN device 204 may, in a service discovery frame, advertise an ability to provide such AP services to other NAN devices 204.

There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN device link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

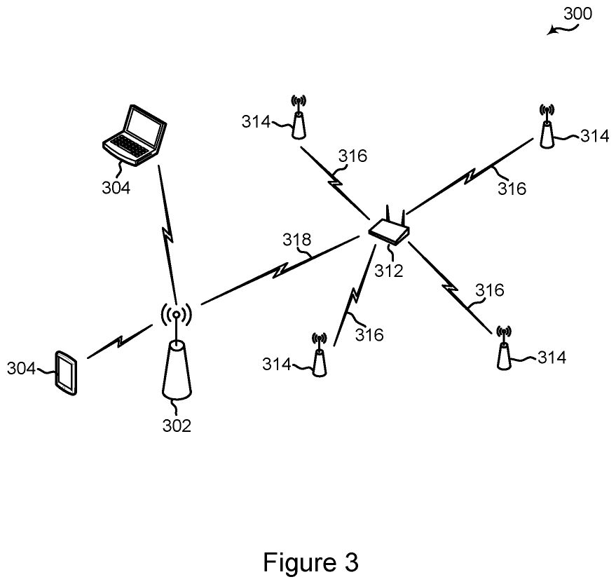

FIG. 3 illustrates an example of a WLAN 300 that supports managing hopping TWTs for wireless networks in accordance with one or more aspects of the present disclosure. According to some aspects, the WLAN 300 can be an example of a mesh network, an IoT network or a sensor network. The WLAN 300 may include multiple wireless communication devices 314. The wireless communication devices 314 may represent various devices such as display devices (for example, TVs, computer monitors, navigation systems, among others), music or other audio or stereo devices, remote control devices (“remotes”), printers, kitchen or other household appliances, among other possibilities.

In some implementations, the wireless communication devices 314 sense, measure, collect or otherwise obtain and process data and then transmit such raw or processed data to an intermediate device 312 for subsequent processing or distribution. Additionally or alternatively, the intermediate device 312 may transmit control information, digital content (for example, audio or video data), configuration information or other instructions to the wireless communication devices 314. The intermediate device 312 and the wireless communication devices 314 can communicate with one another via wireless links 316. In some implementations, the wireless links 316 include Bluetooth links or other PAN or short-range communication links.

In some examples, the intermediate device 312 also may be configured for wireless communication with other networks such as with a Wi-Fi WLAN or a wireless (for example, cellular) wide area network (WWAN), which may, in turn, provide access to external networks including the Internet. For example, the intermediate device 312 may be configured to associate and communicate, over a Wi-Fi link 318, with an AP 302 of a WLAN network, which also may serve various STAs 304. In some implementations, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some implementations, the intermediate device 312 can be configured to analyze, preprocess and aggregate data received from the wireless communication devices 314 locally at the edge before transmitting it to other devices or external networks via the Wi-Fi link 318. The intermediate device 312 also can be configured to provide additional security for the IoT network and the data it transports.

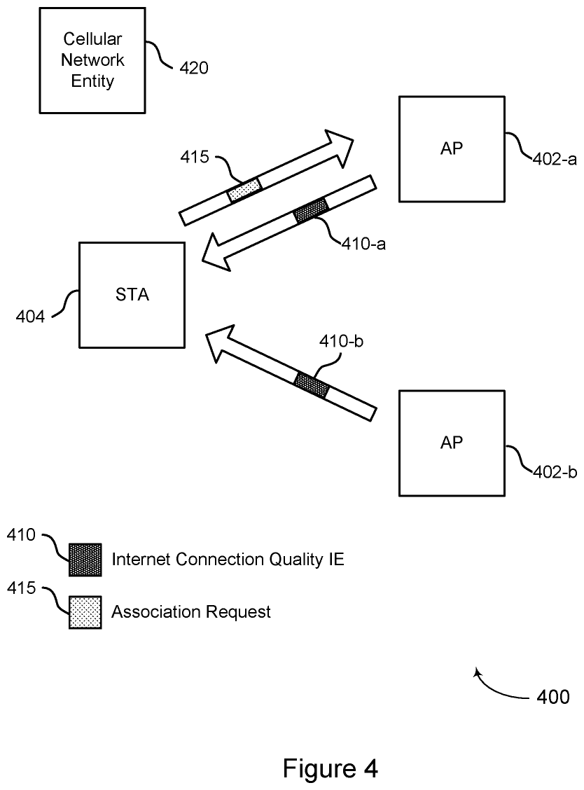

FIG. 4 illustrates an example of a WLAN 400 that supports advertisement of wireless connection quality estimation in accordance with one or more aspects of the present disclosure. The WLAN 400 may implement or be implemented by one or more aspects of the WLAN 100, the WLAN 200, and the WLAN 300. For example, the WLAN 400 may include a first AP 402-a, a second AP 402-b, and one or more STAs 404, which may be examples of the corresponding devices as described with reference to FIGS. 1-3.

In the example of FIG. 4, the APs 402 may transmit Internet connection quality IE 410 that may be received at STA 404. The Internet connection quality IE 410 may be transmitted, for example, in a beacon transmission or in a probe response. For example, the first AP 402-a may transmit a first Internet connection quality IE 410-a and the second AP 402-b may transmit a second Internet connection quality IE 410-b. The STA 404 may receive each of the Internet connection quality IEs 410, and select an AP 402 based on one or more metrics provided in the associated Internet connection quality IE 410 and one or more connection quality criteria (for example, whether the AP 102 has Internet connectivity, one or more threshold values associated with the one or more metrics associated with Internet access, or any combinations thereof). The STA 404 may transmit an association request 415 to the selected AP 402. In some examples, the Internet connection quality IE 410 may be a vendor IE.

In some examples, the Internet connection quality IE 410 may be broadcast with each beacon frame, and may include a number of fields that provide associated connection metrics. For example, the Internet connection quality IE 410 may include an Internet reachability field that may provide a binary indication of Internet reachability for the AP, an Internet link latency field, an uplink bandwidth field that indicates available uplink bandwidth, and a downlink bandwidth field that indicates available downlink bandwidth. The STA 404 may make steering decisions between different APs 402 or between a cellular link with cellular network entity 420 and a link with an AP 402, without connecting to any APs. In some examples, the APs 402 may periodically update the metrics provided with the Internet connection quality IE 410. For example, the metrics may be updated every 50 beacon frames, although other periodicities may be used.

Such techniques may allow the STA 404 to avoid connecting to an ap 402 that is unable to reach the Internet, or that has relatively poor connection metrics. Further, such techniques may allow the STA 404 to avoid roaming to an AP 402 which cannot reach the Internet. Additionally, the STA 404 and APs 402 may avoid sending a variety of different packets associated with Internet reachability and connection quality testing, which may help enhance network efficiency. Techniques as discussed herein may also enable the STA 404 to efficiently steer data over less loaded APs 402, without connecting to each one available, and also to efficiently steer data over multiple wireless network types (for example, in examples in which an estimated AP 402 Internet quality available is less than observed over cellular, the STA 404 may decide to remain on cellular despite the presence of a Wi-Fi connection via APs 402). In some examples, the proposed metrics can be combined with the 802.11k QBSS Load IE metrics, and the STA 404 may evaluate metrics associated with a WLAN associated with the APs 402 along with the Internet connection metrics to obtain an indication of the network link quality between the client and the Internet.

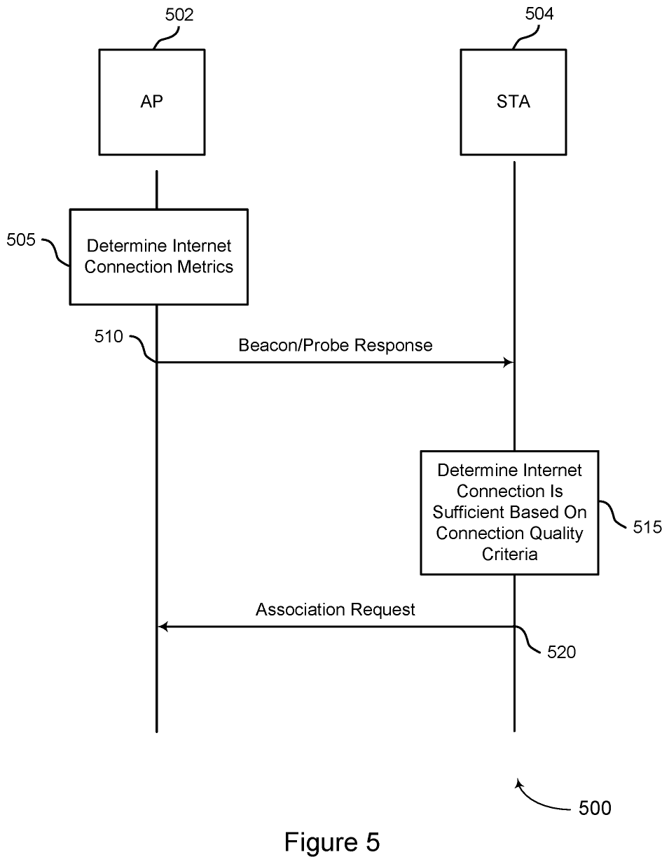

FIG. 5 illustrates an example of a process flow 500 that supports advertisement of wireless connection quality estimation in accordance with one or more aspects of the present disclosure. In some examples, the process flow 500 may include example operations associated with an AP 502 and a STA 504, which may be examples of the corresponding devices as described with reference to FIGS. 1-4. The operations performed by the AP 502 and the STA 504 may support improvements to communications between one or both of the STA 504 and the AP 502. In the following description of the process flow 500, operations between the STA 504 and the AP 502 may occur in a different order or at different times than as shown. Some operations may also be omitted from the process flow 500, and other operations may be added to the process flow 500.

At 505, the AP 502 may determine one or more Internet connection metrics. for example, the AP 502 may determine whether the Internet is reachable, and in examples in which the Internet is reachable, the AP 502 may determine one or more of an Internet link latency, an available uplink bandwidth, or an available downlink bandwidth. At 510, the AP 502 may transmit a beacon frame or probe response that includes an Internet connection quality IE that provides the determined Internet connection metrics.

At 515, the STA 504 may determine whether the Internet connection available at the AP 502 is sufficient based on connection quality criteria. For example, the STA 504 may determine whether the AP 502 has Internet connectivity, one or more threshold values associated with the one or more metrics associated with Internet access, or any combination thereof. At 520, the STA 504 may transmit an association request to the AP 502, based on a determination that the Internet connection via the AP 502 will be sufficient for the STA 504.

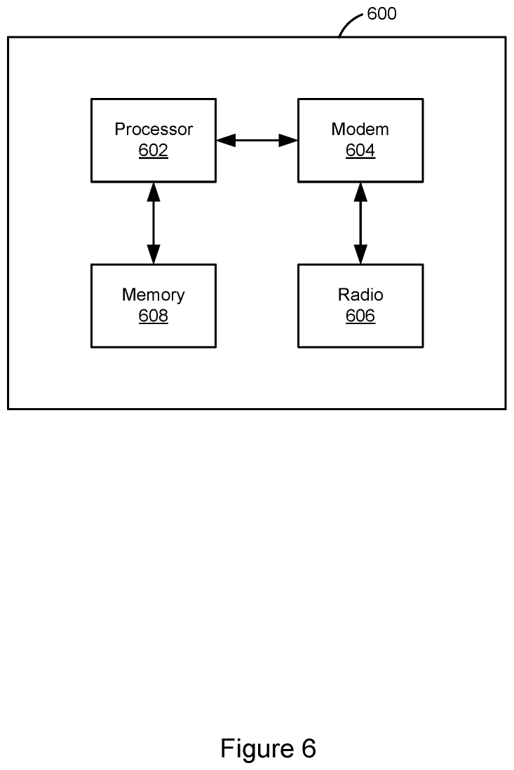

FIG. 6 illustrates an example of a wireless communication device 600 that supports managing hopping TWTs for wireless networks in accordance with one or more aspects of the present disclosure. In some implementations, the wireless communication device 600 can be an example of a device for use in a STA such as one of the STAs 104 described above with reference to FIG. 1. In some implementations, the wireless communication device 600 can be an example of a device for use in an AP such as the AP 102 described above with reference to FIG. 1. The wireless communication device 600 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 600 can be, or can include, a chip, system on chip (SoC), chipset, package or device that includes one or more modems 604, for example, a Wi-Fi (IEEE 802.11 compliant) modem. In some implementations, the one or more modems 604 (collectively “the modem 604”) additionally include a WWAN modem (for example, a 3GPP 4G LTE or 5G compliant modem). In some implementations, the wireless communication device 600 also includes one or more processors, processing blocks or processing elements 602 (collectively “the processor 602”) coupled with the modem 604. In some implementations, the wireless communication device 600 additionally includes one or more radios 606 (collectively “the radio 606”) coupled with the modem 604. In some implementations, the wireless communication device 600 further includes one or more memory blocks or elements 608 (collectively “the memory 608”) coupled with the processor 602 or the modem 604.

The modem 604 can include an intelligent hardware block or device such as, for example, an application-specific integrated circuit (ASIC) among other possibilities. The modem 604 is generally configured to implement a PHY layer, and in some implementations, also a portion of a MAC layer (for example, a hardware portion of the MAC layer). For example, the modem 604 is configured to modulate packets and to output the modulated packets to the radio 606 for transmission over the wireless medium. The modem 604 is similarly configured to obtain modulated packets received by the radio 606 and to demodulate the packets to provide demodulated packets. In addition to a modulator and a demodulator, the modem 604 may further include digital signal processing (DSP) circuitry, automatic gain control (AGC) circuitry, a coder, a decoder, a multiplexer and a demultiplexer. For example, while in a transmission mode, data obtained from the processor 602 may be provided to an encoder, which encodes the data to provide coded bits. The coded bits may then be mapped to a number Nss of spatial streams for spatial multiplexing or a number NSTS of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 606. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 606, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 602) for processing, evaluation or interpretation.

The radio 606 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 600 can include, or be coupled with, multiple transmit antennas (each with a corresponding transmit chain) and multiple receive antennas (each with a corresponding receive chain). The symbols output from the modem 604 are provided to the radio 606, which then transmits the symbols via the coupled antennas. Similarly, symbols received via the antennas are obtained by the radio 606, which then provides the symbols to the modem 604.

The processor 602 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 602 processes information received through the radio 606 and the modem 604, and processes information to be output through the modem 604 and the radio 606 for transmission through the wireless medium. For example, the processor 602 may implement a control plane and at least a portion of a MAC layer configured to perform various operations related to the generation, transmission, reception and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 602 may generally control the modem 604 to cause the modem to perform various operations described above.

The memory 608 can include tangible storage media such as random-access memory (RAM) or read-only memory (ROM), or combinations thereof. The memory 608 also can store non-transitory processor- or computer-executable software (SW) code containing instructions that, when executed by the processor 602, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

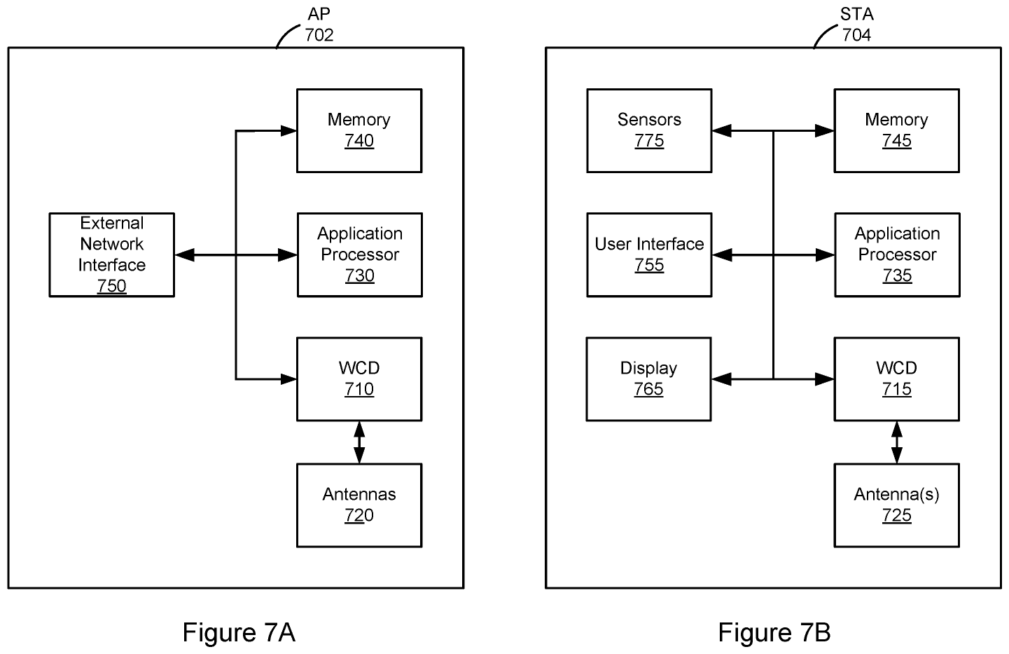

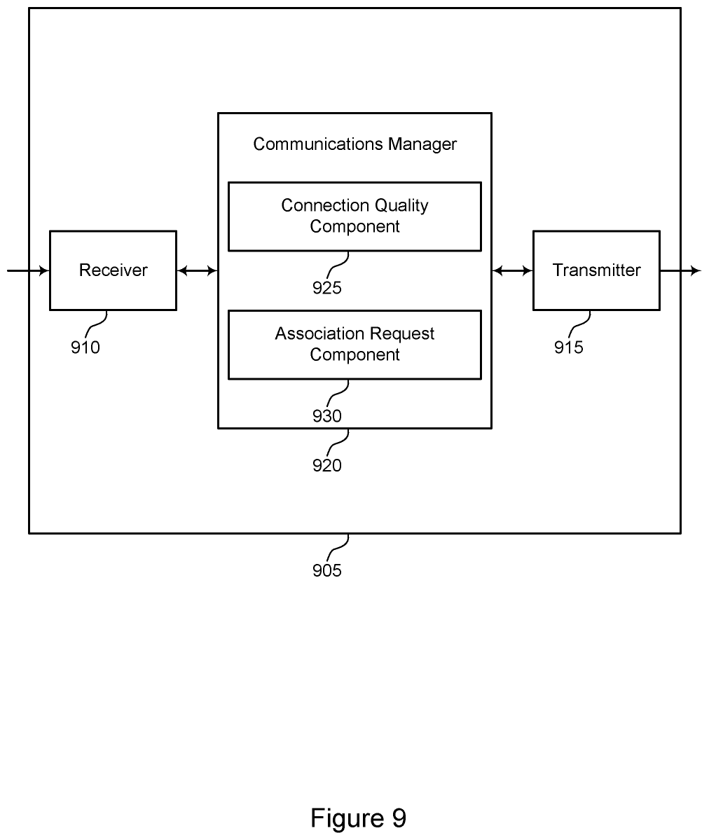

FIG. 7A illustrates an example of a wireless communication device that supports managing hopping TWTs for wireless networks in accordance with one or more aspects of the present disclosure. For example, the AP 702 can be an example implementation of the AP 702 described with reference to FIG. 1. The AP 702 includes a wireless communication device (WCD) 710 (although the AP 702 may itself also be referred to generally as a wireless communication device as used herein). For example, the wireless communication device 710 may be an example implementation of the wireless communication device 900 described with reference to FIG. 9. The AP 702 also includes multiple antennas 720 coupled with the wireless communication device 710 to transmit and receive wireless communications. In some implementations, the AP 702 additionally includes an application processor 730 coupled with the wireless communication device 710, and a memory 740 coupled with the application processor 730. The AP 702 further includes at least one external network interface 750 that enables the AP 702 to communicate with a core network or backhaul network to gain access to external networks including the Internet. For example, the external network interface 750 may include one or both of a wired (for example, Ethernet) network interface and a wireless network interface (such as a WWAN interface). Ones of the aforementioned components can communicate with other ones of the components directly or indirectly, over at least one bus. The AP 702 further includes a housing that encompasses the wireless communication device 710, the application processor 730, the memory 740, and at least portions of the antennas 720 and external network interface 750.

FIG. 7B illustrates an example of a wireless communication device that supports managing hopping TWTs for wireless networks in accordance with one or more aspects of the present disclosure. For example, the STA 704 can be an example implementation of the STA 74 described with reference to FIG. 1. The STA 704 includes a wireless communication device 715 (although the STA 704 may itself also be referred to generally as a wireless communication device as used herein). For example, the wireless communication device 715 may be an example implementation of the wireless communication device 900 described with reference to FIG. 9. The STA 704 also includes one or more antennas 725 coupled with the wireless communication device 715 to transmit and receive wireless communications. The STA 704 additionally includes an application processor 735 coupled with the wireless communication device 715, and a memory 745 coupled with the application processor 735. In some implementations, the STA 704 further includes a user interface (UI) 755 (such as a touchscreen or keypad) and a display 765, which may be integrated with the UI 755 to form a touchscreen display. In some implementations, the STA 704 may further include one or more sensors 775 such as, for example, one or more inertial sensors, accelerometers, temperature sensors, pressure sensors, or altitude sensors. Ones of the aforementioned components can communicate with other ones of the components directly or indirectly, over at least one bus. The STA 704 further includes a housing that encompasses the wireless communication device 715, the application processor 735, the memory 745, and at least portions of the antennas 725, UI 755, and display 765.

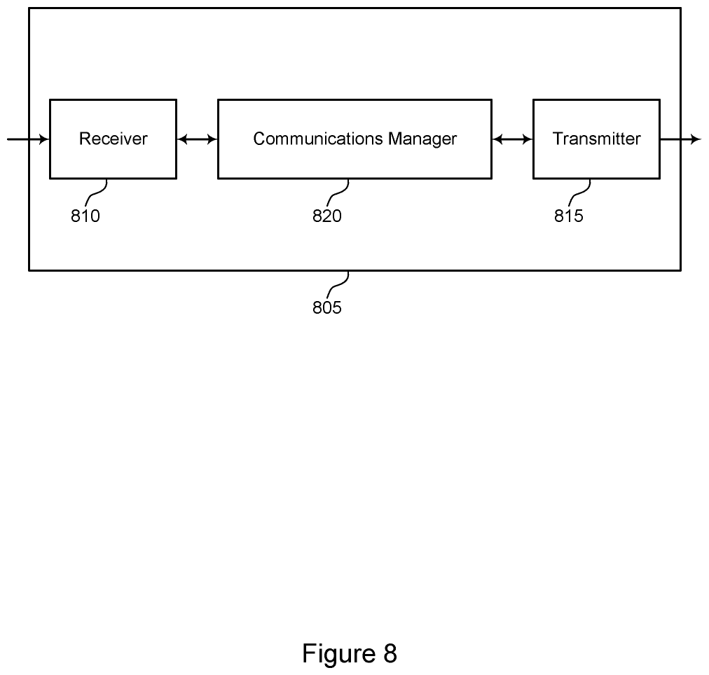

FIG. 8 shows a block diagram of a device 805 that supports advertisement of wireless connection quality estimation in accordance with one or more aspects of the present disclosure. The device 805 may be an example of aspects of an STA as described herein. The device 805 may include a receiver 810, a transmitter 815, and a communications manager 820. The device 805 may also include a processor. Each of these components may be in communication with one another (for example, via one or more buses).

The receiver 810 may provide a means for receiving information such as packets, user data, control information, or any combination thereof associated with various information channels (for example, control channels, data channels, information channels related to advertisement of wireless connection quality estimation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example, control channels, data channels, information channels related to advertisement of wireless connection quality estimation). In some examples, the transmitter 815 may be co-located with a receiver 810 in a transceiver component. The transmitter 815 may utilize a single antenna or a set of multiple antennas.

The communications manager 820, the receiver 810, the transmitter 815, or various combinations thereof or various components thereof may be examples of means for performing various aspects of advertisement of wireless connection quality estimation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (for example, in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 820, the receiver 810, the transmitter 815, or various combinations or components thereof may be implemented in code (for example, as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 820 may be configured to perform various operations (for example, receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a wireless station in accordance with examples as disclosed herein. For example, the communications manager 820 may be configured as or otherwise support a means for receiving a first message from a first wireless access point, the first message including a beacon message or probe response that indicates a first network connection quality associated with one or more metrics associated with Internet access via the first wireless access point. The communications manager 820 may be configured as or otherwise support a means for transmitting an association request to the first wireless access point based on the first network connection quality and one or more Internet connection quality criteria.

By including or configuring the communications manager 820 in accordance with examples as described herein, the device 805 (for example, a processor controlling or otherwise coupled with the receiver 810, the transmitter 815, the communications manager 820, or a combination thereof) may support techniques for advertisement of wireless connection quality estimation that may reduce access latency, avoid roaming to an AP that has a relatively poor connection or no Internet connection, provide improvements to power consumption and connection latency, and enhance reliability for communications.

FIG. 9 shows a block diagram of a device 905 that supports advertisement of wireless connection quality estimation in accordance with one or more aspects of the present disclosure. The device 905 may be an example of aspects of a device 805 or an STA 104 as described herein. The device 905 may include a receiver 910, a transmitter 915, and a communications manager 920. The device 905 may also include a processor. Each of these components may be in communication with one another (for example, via one or more buses).

The receiver 910 may provide a means for receiving information such as packets, user data, control information, or any combination thereof associated with various information channels (for example, control channels, data channels, information channels related to advertisement of wireless connection quality estimation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example, control channels, data channels, information channels related to advertisement of wireless connection quality estimation). In some examples, the transmitter 915 may be co-located with a receiver 910 in a transceiver component. The transmitter 915 may utilize a single antenna or a set of multiple antennas.

The device 905, or various components thereof, may be an example of means for performing various aspects of advertisement of wireless connection quality estimation as described herein. For example, the communications manager 920 may include a connection quality component 925 an association request component 930, or any combination thereof. The communications manager 920 may be an example of aspects of a communications manager 820 as described herein. In some examples, the communications manager 920, or various components thereof, may be configured to perform various operations (for example, receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a wireless station in accordance with examples as disclosed herein. The connection quality component 925 may be configured as or otherwise support a means for receiving a first message from a first wireless access point, the first message including a beacon message or probe response that indicates a first network connection quality associated with one or more metrics associated with Internet access via the first wireless access point. The association request component 930 may be configured as or otherwise support a means for transmitting an association request to the first wireless access point based on the first network connection quality and one or more Internet connection quality criteria.

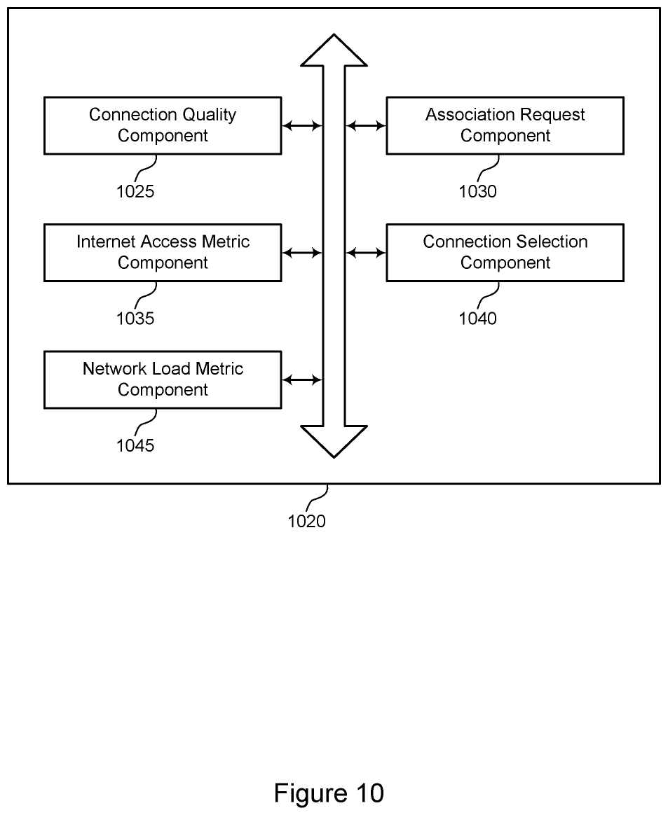

FIG. 10 shows a block diagram of a communications manager 1020 that supports advertisement of wireless connection quality estimation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of advertisement of wireless connection quality estimation as described herein. For example, the communications manager 1020 may include a connection quality component 1025, an association request component 1030, an Internet access metric component 1035, a connection selection component 1040, a network load metric component 1045, or any combination thereof. Each of these components may communicate, directly or indirectly, with one another (for example, via one or more buses).

The communications manager 1020 may support wireless communication at a wireless station in accordance with examples as disclosed herein. The connection quality component 1025 may be configured as or otherwise support a means for receiving a first message from a first wireless access point, the first message including a beacon message or probe response that indicates a first network connection quality associated with one or more metrics associated with Internet access via the first wireless access point. The association request component 1030 may be configured as or otherwise support a means for transmitting an association request to the first wireless access point based on the first network connection quality and one or more Internet connection quality criteria.

In some examples, the connection quality component 1025 may be configured as or otherwise support a means for receiving, from at least a second wireless access point, a second message, the second message including a second beacon message or second probe response that indicates a second network connection quality associated with one or more metrics associated with Internet access via the second wireless access point. In some examples, the connection quality component 1025 may be configured as or otherwise support a means for where the transmitting the association request to the first wireless access point is further based on comparing the first network connection quality and the second network connection quality.

In some examples, the first message includes a beacon frame transmission that includes an information element that provides the one or more metrics associated with Internet access via the first wireless access point. In some examples, the one or more metrics may include an Internet reachability indication indicating whether Internet access is available via the first wireless access point, an Internet link latency indication indicating a latency associated with an Internet connection of the first wireless access point, an available uplink bandwidth of the Internet connection of the first wireless access point, an available downlink bandwidth of the Internet connection of the first wireless access point, or any combination thereof.

In some examples, to support transmitting, the connection selection component 1040 may be configured as or otherwise support a means for selecting the first wireless access point for an Internet connection based on the first network connection quality and at least one other network connection quality associated with Internet access via at least one other network entity different than the first wireless access point. In some examples, the connection selection component 1040 may be configured as or otherwise support a means for selecting a different network entity other than the first wireless access point for an Internet connection based on the first network connection quality and at least one other network connection quality associated with Internet access via the different network entity. In some examples, the first wireless access point is associated with a first wireless local area network, and the different network entity is associated with a second wireless local area network or a cellular radio access network.

In some examples, the one or more metrics associated with Internet access via the first wireless access point are updated by the first wireless access point according to a first periodicity associated with the first wireless access point.

In some examples, the one or more Internet connection quality criteria include one or more of whether the first wireless access point has Internet connectivity, one or more threshold values associated with the one or more metrics associated with Internet access, or any combinations thereof.

In some examples, the connection selection component 1040 may be configured as or otherwise support a means for monitoring one or more messages of one or more other wireless access points that each indicate an associated network connection quality associated with a respective wireless access point of the one or more other wireless access points. In some examples, the connection selection component 1040 may be configured as or otherwise support a means for selecting a second wireless access point for an Internet connection based at least in part a second network connection quality associated with one or more metrics associated with Internet access via the second wireless access point indicating Internet connectivity is available via the second wireless access point.

In some examples, the connection selection component 1040 may be configured as or otherwise support a means for selecting a network entity associated with a cellular radio access network for Internet access based on one or more of the one or more metrics associated with Internet access via the first wireless access point being below a threshold value.

In some examples, the network load metric component 1045 may be configured as or otherwise support a means for receiving, from each of two or more wireless access points, a local area load metric information element and an Internet connection quality information element, the local area load metric information element indicates one or more load metrics of an associated wireless local area network, and an Internet connection quality information element that indicates one or more Internet access metrics. In some examples, the network load metric component 1045 may be configured as or otherwise support a means for selecting the first wireless access point from the two or more wireless access points based on the local area load metric information element and the Internet connection quality information element of each of the two or more wireless access points. In some examples, the local area load metric information element is a quality of service enhanced basic service set load information element that indicates the one or more load metrics of the associated wireless local area network.

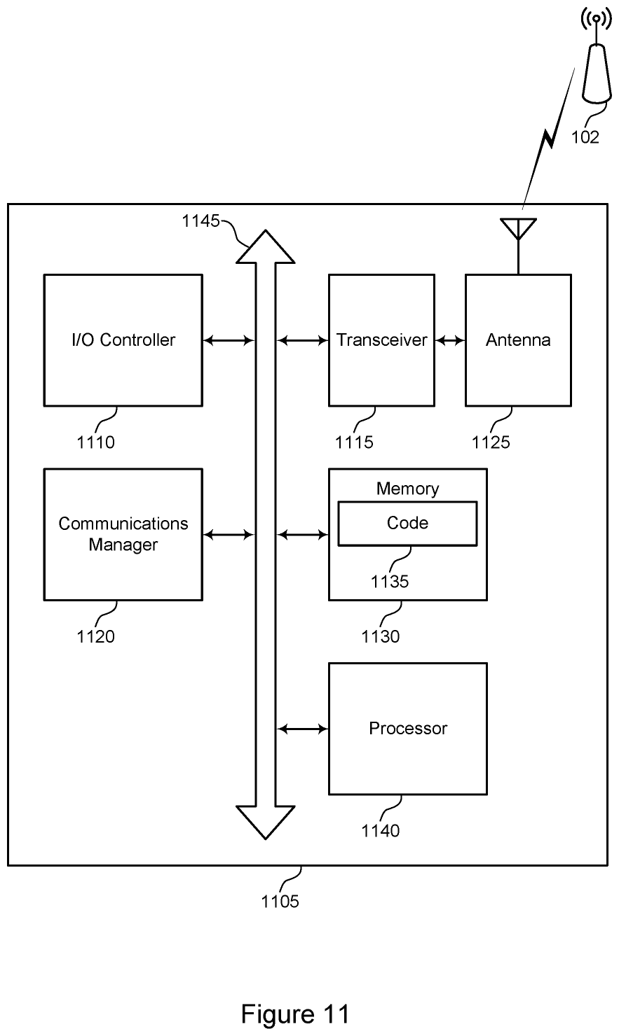

FIG. 11 shows a diagram of a system including a device 1105 that supports advertisement of wireless connection quality estimation in accordance with one or more aspects of the present disclosure. The device 1105 may be an example of or include the components of a device 805, a device 905, or an STA as described herein. The device 1105 may include components for bi-directional voice and data communications including components for transmitting and receiving communications, such as a communications manager 1120, an I/O controller 1110, a transceiver 1115, an antenna 1125, a memory 1130, code 1135, and a processor 1140. These components may be in electronic communication or otherwise coupled (for example, operatively, communicatively, functionally, electronically, electrically) via one or more buses (for example, a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In some other cases, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets and provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. In some cases, the memory 1130 may contain, among other things, a BIOS which may control basic hardware or software operation such as the interaction with peripheral components or devices.

The processor 1140 may include an intelligent hardware device, (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (for example, the memory 1130) to cause the device 1105 to perform various functions (for example, functions or tasks supporting advertisement of wireless connection quality estimation). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a wireless station in accordance with examples as disclosed herein. For example, the communications manager 1120 may be configured as or otherwise support a means for receiving a first message from a first wireless access point, the first message including a beacon message or probe response that indicates a first network connection quality associated with one or more metrics associated with Internet access via the first wireless access point. The communications manager 1120 may be configured as or otherwise support a means for transmitting an association request to the first wireless access point based on the first network connection quality and one or more Internet connection quality criteria.

By including or configuring the communications manager 1120 in accordance with examples as described herein, the device 1105 may support techniques for advertisement of wireless connection quality estimation that may reduce access latency, avoid roaming to an AP that has a relatively poor connection or no Internet connection, provide improvements to power consumption and connection latency, and enhance reliability for communications.

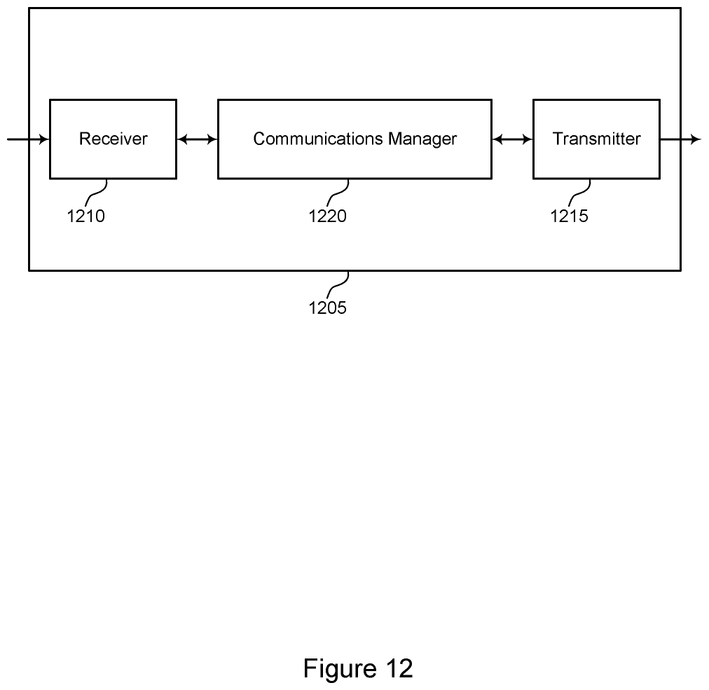

FIG. 12 shows a block diagram of a device 1205 that supports advertisement of wireless connection quality estimation in accordance with one or more aspects of the present disclosure. The device 1205 may be an example of aspects of an AP as described herein. The device 1205 may include a receiver 1210, a transmitter 1215, and a communications manager 1220. The device 1205 may also include a processor. Each of these components may be in communication with one another (for example, via one or more buses).

The receiver 1210 may provide a means for receiving information such as packets, user data, control information, or any combination thereof associated with various information channels (for example, control channels, data channels, information channels related to advertisement of wireless connection quality estimation). Information may be passed on to other components of the device 1205. The receiver 1210 may utilize a single antenna or a set of multiple antennas.

The transmitter 1215 may provide a means for transmitting signals generated by other components of the device 1205. The transmitter 1215 may utilize a single antenna or a set of multiple antennas.

The communications manager 1220, the receiver 1210, the transmitter 1215, or various combinations thereof or various components thereof may be examples of means for performing various aspects of advertisement of wireless connection quality estimation as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (for example, in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 1220, the receiver 1210, the transmitter 1215, or various combinations or components thereof may be implemented in code (for example, as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 1220 may be configured to perform various operations (for example, receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a wireless access point in accordance with examples as disclosed herein. For example, the communications manager 1220 may be configured as or otherwise support a means for transmitting a first message to one or more wireless stations, the first message including a beacon message or probe response, and the first message including a network connection quality indication associated with one or more metrics associated with Internet access via the wireless access point. The communications manager 1220 may be configured as or otherwise support a means for receiving, from at least a first wireless station of the one or more wireless stations, an association request for Internet access via the wireless access point.

By including or configuring the communications manager 1220 in accordance with examples as described herein, the device 1205 (for example, a processor controlling or otherwise coupled with the receiver 1210, the transmitter 1215, the communications manager 1220, or a combination thereof) may support techniques for advertisement of wireless connection quality estimation that may reduce access latency, avoid roaming to an AP that has a relatively poor connection or no Internet connection, provide improvements to power consumption and connection latency, and enhance reliability for communications.

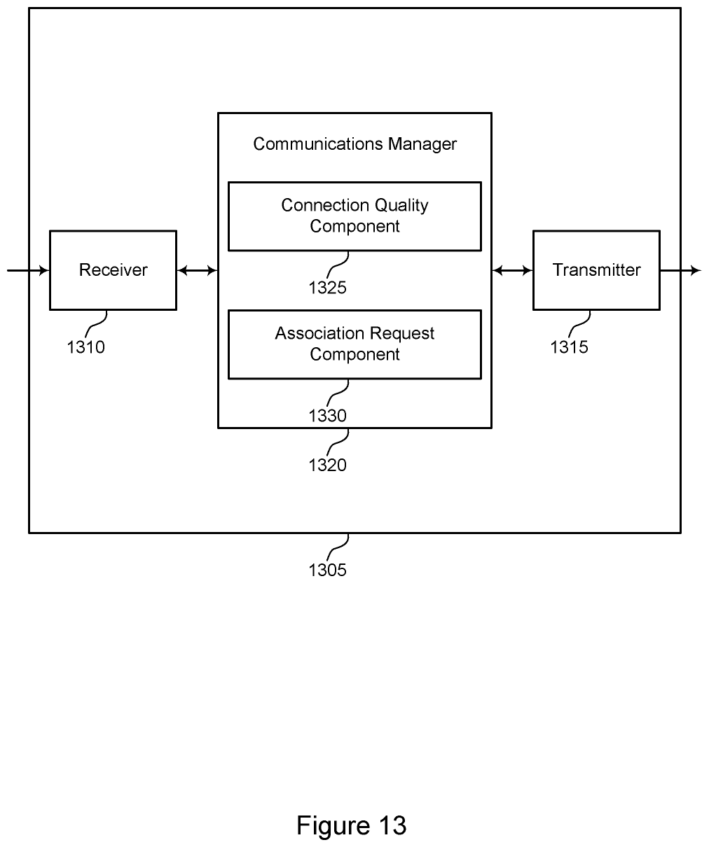

FIG. 13 shows a block diagram 1300 of a device 1305 that supports advertisement of wireless connection quality estimation in accordance with one or more aspects of the present disclosure. The device 1305 may be an example of aspects of a device 1205 or an AP 102 as described herein. The device 1305 may include a receiver 1310, a transmitter 1315, and a communications manager 1320. The device 1305 may also include a processor. Each of these components may be in communication with one another (for example, via one or more buses).

The receiver 1310 may provide a means for receiving information such as packets, user data, control information, or any combination thereof associated with various information channels (for example, control channels, data channels, information channels related to advertisement of wireless connection quality estimation). Information may be passed on to other components of the device 1305. The receiver 1310 may utilize a single antenna or a set of multiple antennas.

The transmitter 1315 may provide a means for transmitting signals generated by other components of the device 1305. The transmitter 1315 may utilize a single antenna or a set of multiple antennas.

The device 1305, or various components thereof, may be an example of means for performing various aspects of advertisement of wireless connection quality estimation as described herein. For example, the communications manager 1320 may include a connection quality component 1325 an association request component 1330, or any combination thereof. The communications manager 1320 may be an example of aspects of a communications manager 1220 as described herein. In some examples, the communications manager 1320, or various components thereof, may be configured to perform various operations (for example, receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a wireless access point in accordance with examples as disclosed herein. The connection quality component 1325 may be configured as or otherwise support a means for transmitting a first message to one or more wireless stations, the first message including a beacon message or probe response, and the first message including a network connection quality indication associated with one or more metrics associated with Internet access via the wireless access point. The association request component 1330 may be configured as or otherwise support a means for receiving, from at least a first wireless station of the one or more wireless stations, an association request for Internet access via the wireless access point.

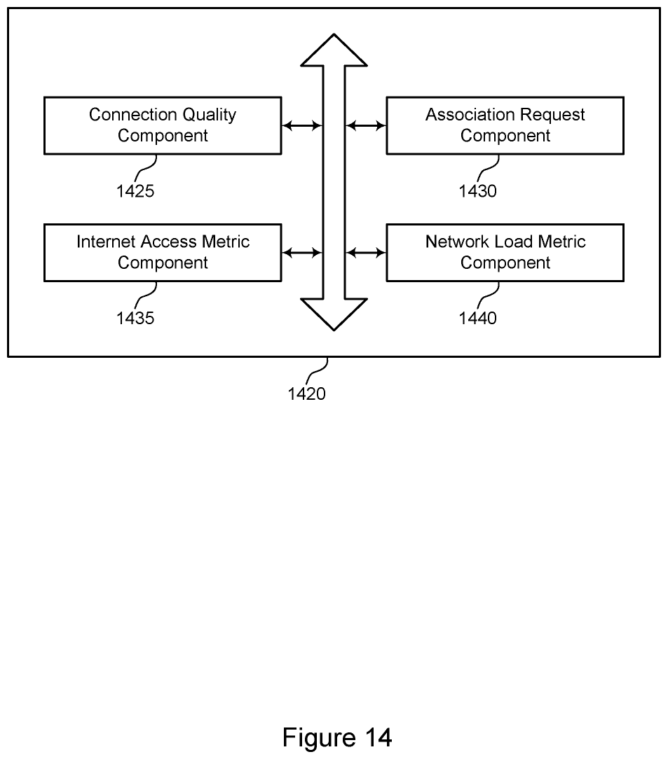

FIG. 14 shows a block diagram of a communications manager 1420 that supports advertisement of wireless connection quality estimation in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of advertisement of wireless connection quality estimation as described herein. For example, the communications manager 1420 may include a connection quality component 1425, an association request component 1430, an Internet access metric component 1435, a network load metric component 1440, or any combination thereof. Each of these components may communicate, directly or indirectly, with one another (for example, via one or more buses).

The communications manager 1420 may support wireless communication at a wireless access point in accordance with examples as disclosed herein. The connection quality component 1425 may be configured as or otherwise support a means for transmitting a first message to one or more wireless stations, the first message including a beacon message or probe response, and the first message including a network connection quality indication associated with one or more metrics associated with Internet access via the wireless access point. The association request component 1430 may be configured as or otherwise support a means for receiving, from at least a first wireless station of the one or more wireless stations, an association request for Internet access via the wireless access point.

In some examples, the first message includes a beacon frame transmission or probe response that includes an information element that provides the one or more metrics associated with Internet access via the wireless access point. In some examples, the one or more metrics associated with Internet access include one or more of an Internet reachability indication indicating whether Internet access is available via the wireless access point, an Internet link latency indication indicating a latency associated with an Internet connection of the wireless access point, an available uplink bandwidth of the Internet connection of the wireless access point, an available downlink bandwidth of the Internet connection of the wireless access point, or any combinations thereof.

In some examples, the connection quality component 1425 may be configured as or otherwise support a means for repeating, according to a first periodicity, the transmitting the first message with an updated network connection quality indication associated with one or more updated metrics associated with Internet access via the wireless access point. In some examples, the first periodicity corresponds to a predetermined quantity of beacon frame transmissions.

In some examples, the network load metric component 1440 may be configured as or otherwise support a means for transmitting, in the first message, a local area load metric information element and an Internet connection quality information element, the local area load metric information element indicating one or more load metrics of a wireless local area network associated with the wireless access point, and the Internet connection quality information element indicating the one or more metrics associated with Internet access via the wireless access point. In some examples, the local area load metric information element is a quality of service enhanced basic service set load information element that indicates the one or more load metrics of the wireless local area network associated with the wireless access point.

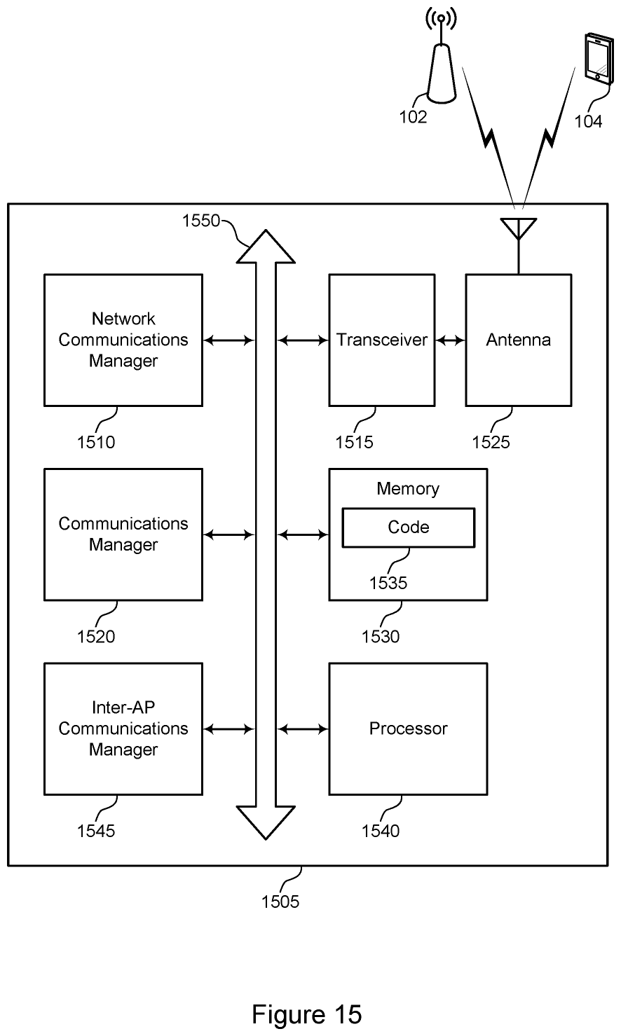

FIG. 15 shows a diagram of a system including a device 1505 that supports advertisement of wireless connection quality estimation in accordance with one or more aspects of the present disclosure. The device 1505 may be an example of or include the components of a device 1205, a device 1305, or an AP as described herein. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-AP communications manager 1545. These components may be in electronic communication or otherwise coupled (for example, operatively, communicatively, functionally, electronically, electrically) via one or more buses (for example, a bus 1550).

The network communications manager 1510 may manage communications with a core network (for example, via one or more wired backhaul links). For example, the network communications manager 1510 may manage the transfer of data communications for client devices, such as one or more STAs 104.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets and provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. In some cases, the memory 1530 may contain, among other things, a BIOS which may control basic hardware or software operation such as the interaction with peripheral components or devices.

The processor 1540 may include an intelligent hardware device, (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (for example, the memory 1530) to cause the device 1505 to perform various functions (for example, functions or tasks supporting advertisement of wireless connection quality estimation). For example, the device 1505 or a component of the device 1505 may include a processor 1540 and memory 1530 coupled with or to the processor 1540, the processor 1540 and memory 1530 configured to perform various functions described herein.

The inter-station communications manager 1545 may manage communications with other APs 102, and may include a controller or scheduler for controlling communications with STAs 104 in cooperation with other APs 102. For example, the inter-station communications manager 1545 may coordinate scheduling for transmissions to APs 102 for various interference mitigation techniques such as beamforming or joint transmission. In some examples, the inter-station communications manager 1545 may provide an X2 interface within an LTE/LTE-A wireless communication network technology to provide communication between APs 102.

The communications manager 1520 may support wireless communication at a wireless access point in accordance with examples as disclosed herein. For example, the communications manager 1520 may be configured as or otherwise support a means for transmitting a first message to one or more wireless stations, the first message including a beacon message or probe response, and the first message including a network connection quality indication associated with one or more metrics associated with Internet access via the wireless access point. The communications manager 1520 may be configured as or otherwise support a means for receiving, from at least a first wireless station of the one or more wireless stations, an association request for Internet access via the wireless access point.

By including or configuring the communications manager 1520 in accordance with examples as described herein, the device 1505 may support techniques for advertisement of wireless connection quality estimation that may reduce access latency, avoid roaming to an AP that has a relatively poor connection or no Internet connection, provide improvements to power consumption and connection latency, and enhance reliability for communications.

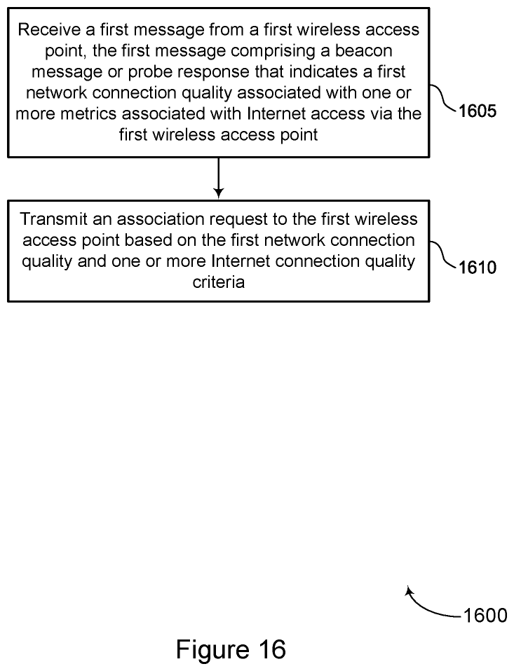

FIG. 16 shows a flowchart illustrating a method 1600 that supports advertisement of wireless connection quality estimation in accordance with one or more aspects of the present disclosure. The operations of the method 1600 may be implemented by an STA or its components as described herein. For example, the operations of the method 1600 may be performed by an STA as described with reference to FIGS. 1 through 11. In some examples, an STA may execute a set of instructions to control the functional elements of the STA to perform the described functions. Additionally, or alternatively, the STA may perform aspects of the described functions using special-purpose hardware.

At 1605, the method may include receiving a first message from a first wireless access point, the first message including a beacon message or probe response that indicates a first network connection quality associated with one or more metrics associated with Internet access via the first wireless access point. The operations of 1605 may be performed in accordance with examples as disclosed herein. In some examples, aspects of the operations of 1605 may be performed by a connection quality component 1025 as described with reference to FIG. 10.

At 1610, the method may include transmitting an association request to the first wireless access point based on the first network connection quality and one or more Internet connection quality criteria. The operations of 1610 may be performed in accordance with examples as disclosed herein. In some examples, aspects of the operations of 1610 may be performed by an association request component 1030 as described with reference to FIG. 10.

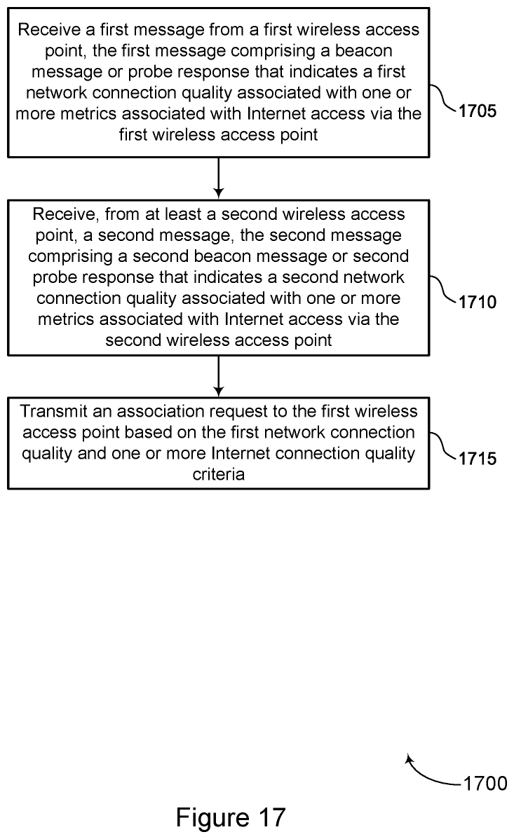

FIG. 17 shows a flowchart illustrating a method 1700 that supports advertisement of wireless connection quality estimation in accordance with one or more aspects of the present disclosure. The operations of the method 1700 may be implemented by an STA or its components as described herein. For example, the operations of the method 1700 may be performed by an STA as described with reference to FIGS. 1 through 11. In some examples, an STA may execute a set of instructions to control the functional elements of the STA to perform the described functions. Additionally, or alternatively, the STA may perform aspects of the described functions using special-purpose hardware.

At 1705, the method may include receiving a first message from a first wireless access point, the first message including a beacon message or probe response that indicates a first network connection quality associated with one or more metrics associated with Internet access via the first wireless access point. The operations of 1705 may be performed in accordance with examples as disclosed herein. In some examples, aspects of the operations of 1705 may be performed by a connection quality component 1025 as described with reference to FIG. 10.

At 1710, the method may include receiving, from at least a second wireless access point, a second message, the second message including a second beacon message or second probe response that indicates a second network connection quality associated with one or more metrics associated with Internet access via the second wireless access point. The operations of 1710 may be performed in accordance with examples as disclosed herein. In some examples, aspects of the operations of 1710 may be performed by a connection quality component 1025 as described with reference to FIG. 10.

At 1715, the method may include transmitting an association request to the first wireless access point based on the first network connection quality and one or more Internet connection quality criteria. The operations of 1715 may be performed in accordance with examples as disclosed herein. In some examples, aspects of the operations of 1715 may be performed by an association request component 1030 as described with reference to FIG. 10. In some cases, the transmitting the association request to the first wireless access point is further based on comparing the first network connection quality and the second network connection quality.

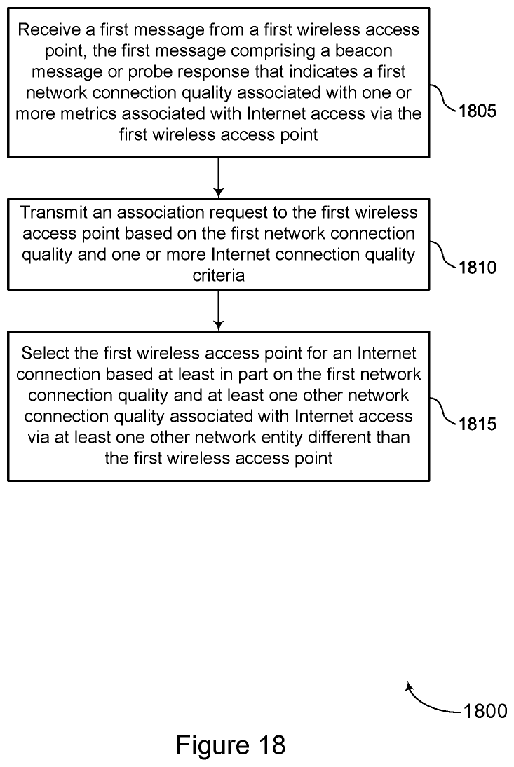

FIG. 18 shows a flowchart illustrating a method 1800 that supports advertisement of wireless connection quality estimation in accordance with one or more aspects of the present disclosure. The operations of the method 1800 may be implemented by an STA or its components as described herein. For example, the operations of the method 1800 may be performed by an STA as described with reference to FIGS. 1 through 11. In some examples, an STA may execute a set of instructions to control the functional elements of the STA to perform the described functions. Additionally, or alternatively, the STA may perform aspects of the described functions using special-purpose hardware.

At 1805, the method may include receiving a first message from a first wireless access point, the first message including a beacon message or probe response that indicates a first network connection quality associated with one or more metrics associated with Internet access via the first wireless access point. The operations of 1805 may be performed in accordance with examples as disclosed herein. In some examples, aspects of the operations of 1805 may be performed by a connection quality component 1025 as described with reference to FIG. 10.

At 1810, the method may include transmitting an association request to the first wireless access point based on the first network connection quality and one or more Internet connection quality criteria. The operations of 1810 may be performed in accordance with examples as disclosed herein. In some examples, aspects of the operations of 1810 may be performed by an association request component 1030 as described with reference to FIG. 10.

At 1815, the method may include selecting the first wireless access point for an Internet connection based on the first network connection quality and at least one other network connection quality associated with Internet access via at least one other network entity different than the first wireless access point. The operations of 1815 may be performed in accordance with examples as disclosed herein. In some examples, aspects of the operations of 1815 may be performed by a connection selection component 1040 as described with reference to FIG. 10.

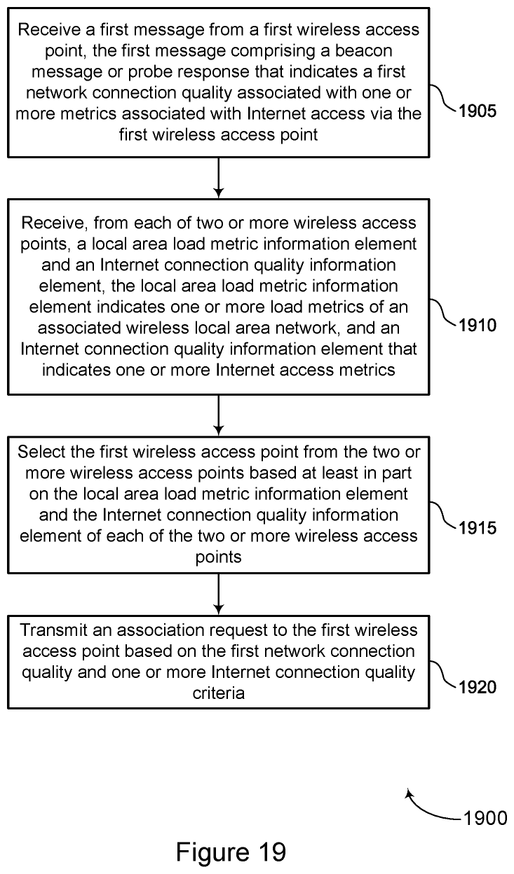

FIG. 19 shows a flowchart illustrating a method 1900 that supports advertisement of wireless connection quality estimation in accordance with one or more aspects of the present disclosure. The operations of the method 1900 may be implemented by an STA or its components as described herein. For example, the operations of the method 1900 may be performed by an STA as described with reference to FIGS. 1 through 11. In some examples, an STA may execute a set of instructions to control the functional elements of the STA to perform the described functions. Additionally, or alternatively, the STA may perform aspects of the described functions using special-purpose hardware.

At 1905, the method may include receiving a first message from a first wireless access point, the first message including a beacon message or probe response that indicates a first network connection quality associated with one or more metrics associated with Internet access via the first wireless access point. The operations of 1905 may be performed in accordance with examples as disclosed herein. In some examples, aspects of the operations of 1905 may be performed by a connection quality component 1025 as described with reference to FIG. 10.

At 1910, the method may include receiving, from each of two or more wireless access points, a local area load metric information element and an Internet connection quality information element, the local area load metric information element indicates one or more load metrics of an associated wireless local area network, and an Internet connection quality information element that indicates one or more Internet access metrics. The operations of 1910 may be performed in accordance with examples as disclosed herein. In some examples, aspects of the operations of 1910 may be performed by a network load metric component 1045 as described with reference to FIG. 10.

At 1915, the method may include selecting the first wireless access point from the two or more wireless access points based on the local area load metric information element and the Internet connection quality information element of each of the two or more wireless access points. The operations of 1915 may be performed in accordance with examples as disclosed herein. In some examples, aspects of the operations of 1915 may be performed by a network load metric component 1045 as described with reference to FIG. 10.

At 1920, the method may include transmitting an association request to the first wireless access point based on the first network connection quality and one or more Internet connection quality criteria. The operations of 1920 may be performed in accordance with examples as disclosed herein. In some examples, aspects of the operations of 1920 may be performed by an association request component 1030 as described with reference to FIG. 10.

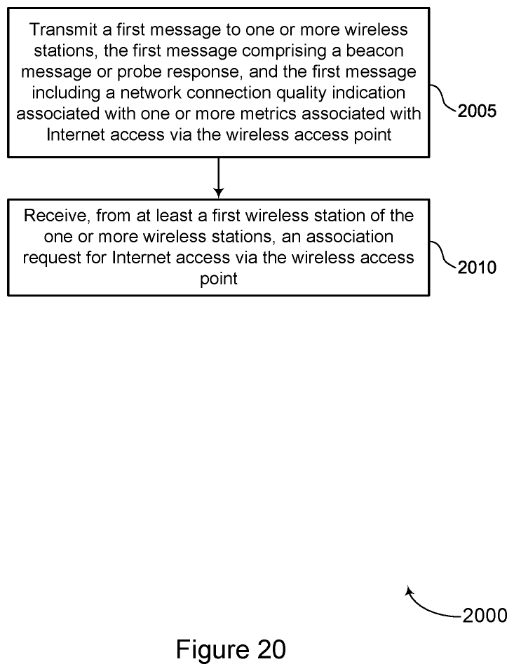

FIG. 20 shows a flowchart illustrating a method 2000 that supports advertisement of wireless connection quality estimation in accordance with one or more aspects of the present disclosure. The operations of the method 2000 may be implemented by an STA or an AP or its components as described herein. For example, the operations of the method 2000 may be performed by an STA as described with reference to FIGS. 1 through 11 or an AP as described with reference to FIGS. 1 through 5 and 12 through 15. In some examples, an STA or an AP may execute a set of instructions to control the functional elements of the STA or the AP to perform the described functions. Additionally, or alternatively, the STA or the AP may perform aspects of the described functions using special-purpose hardware.

At 2005, the method may include transmitting a first message to one or more wireless stations, the first message including a beacon message or probe response, and the first message including a network connection quality indication associated with one or more metrics associated with Internet access via the wireless access point. The operations of 2005 may be performed in accordance with examples as disclosed herein. In some examples, aspects of the operations of 2005 may be performed by a connection quality component 1025 or a connection quality component 1425 as described with reference to FIGS. 10 and 14.

At 2010, the method may include receiving, from at least a first wireless station of the one or more wireless stations, an association request for Internet access via the wireless access point. The operations of 2010 may be performed in accordance with examples as disclosed herein. In some examples, aspects of the operations of 2010 may be performed by an association request component 1030 or an association request component 1430 as described with reference to FIGS. 10 and 14.

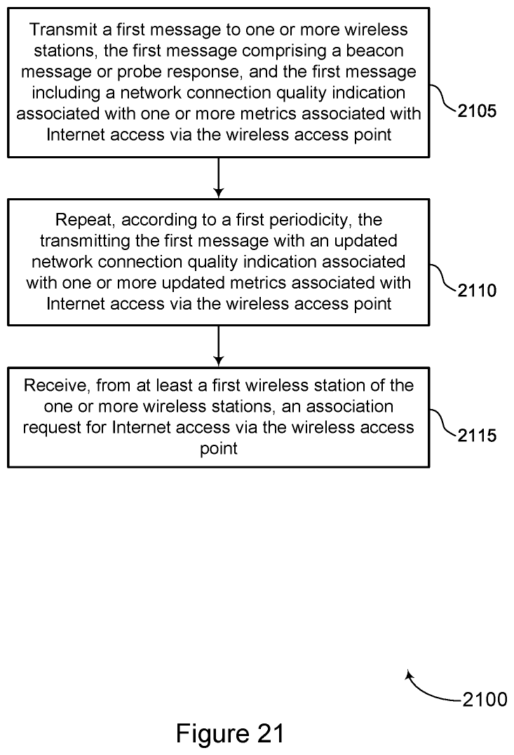

FIG. 21 shows a flowchart illustrating a method 2100 that supports advertisement of wireless connection quality estimation in accordance with one or more aspects of the present disclosure. The operations of the method 2100 may be implemented by an STA or an AP or its components as described herein. For example, the operations of the method 2100 may be performed by an STA as described with reference to FIGS. 1 through 11 or an AP as described with reference to FIGS. 1 through 5 and 12 through 15. In some examples, an STA or an AP may execute a set of instructions to control the functional elements of the STA or the AP to perform the described functions. Additionally, or alternatively, the STA or the AP may perform aspects of the described functions using special-purpose hardware.

At 2105, the method may include transmitting a first message to one or more wireless stations, the first message including a beacon message or probe response, and the first message including a network connection quality indication associated with one or more metrics associated with Internet access via the wireless access point. The operations of 2105 may be performed in accordance with examples as disclosed herein. In some examples, aspects of the operations of 2105 may be performed by a connection quality component 1025 or a connection quality component 1425 as described with reference to FIGS. 10 and 14.

At 2110, the method may include repeating, according to a first periodicity, the transmitting the first message with an updated network connection quality indication associated with one or more updated metrics associated with Internet access via the wireless access point. The operations of 2110 may be performed in accordance with examples as disclosed herein. In some examples, aspects of the operations of 2110 may be performed by a connection quality component 1025 or a connection quality component 1425 as described with reference to FIGS. 10 and 14.

At 2115, the method may include receiving, from at least a first wireless station of the one or more wireless stations, an association request for Internet access via the wireless access point. The operations of 2115 may be performed in accordance with examples as disclosed herein. In some examples, aspects of the operations of 2115 may be performed by an association request component 1030 or an association request component 1430 as described with reference to FIGS. 10 and 14.

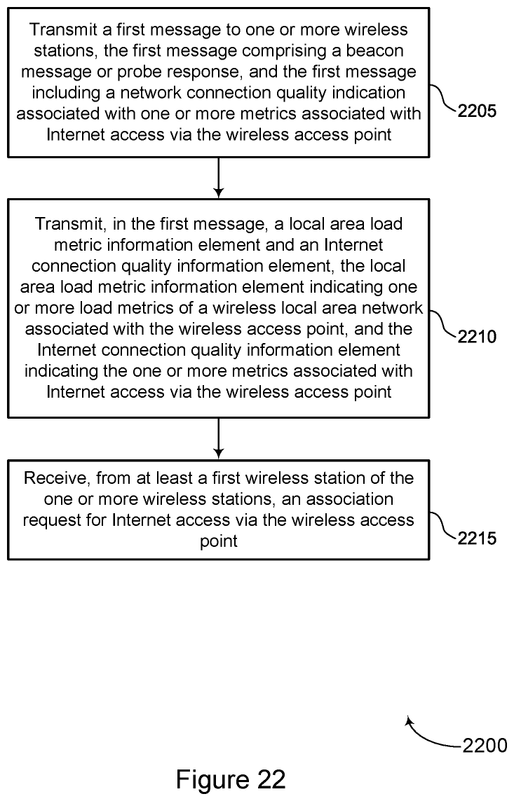

FIG. 22 shows a flowchart illustrating a method 2200 that supports advertisement of wireless connection quality estimation in accordance with one or more aspects of the present disclosure. The operations of the method 2200 may be implemented by an STA or an AP or its components as described herein. For example, the operations of the method 2200 may be performed by an STA as described with reference to FIGS. 1 through 11 or an AP as described with reference to FIGS. 1 through 5 and 12 through 15. In some examples, an STA or an AP may execute a set of instructions to control the functional elements of the STA or the AP to perform the described functions. Additionally, or alternatively, the STA or the AP may perform aspects of the described functions using special-purpose hardware.

At 2205, the method may include transmitting a first message to one or more wireless stations, the first message including a beacon message or probe response, and the first message including a network connection quality indication associated with one or more metrics associated with Internet access via the wireless access point. The operations of 2205 may be performed in accordance with examples as disclosed herein. In some examples, aspects of the operations of 2205 may be performed by a connection quality component 1025 or a connection quality component 1425 as described with reference to FIGS. 10 and 14.

At 2210, the method may include transmitting, in the first message, a local area load metric information element and an Internet connection quality information element, the local area load metric information element indicating one or more load metrics of a wireless local area network associated with the wireless access point, and the Internet connection quality information element indicating the one or more metrics associated with Internet access via the wireless access point. The operations of 2210 may be performed in accordance with examples as disclosed herein. In some examples, aspects of the operations of 2210 may be performed by a network load metric component 1045 or a network load metric component 1440 as described with reference to FIGS. 10 and 14.

At 2215, the method may include receiving, from at least a first wireless station of the one or more wireless stations, an association request for Internet access via the wireless access point. The operations of 2215 may be performed in accordance with examples as disclosed herein. In some examples, aspects of the operations of 2215 may be performed by an association request component 1030 or an association request component 1430 as described with reference to FIGS. 10 and 14.

The following provides an overview of aspects of the present disclosure:

Aspect 1: A method for wireless communication at a wireless station, comprising: receiving a first message from a first wireless access point, the first message comprising a beacon message or probe response that indicates a first network connection quality associated with one or more metrics associated with Internet access via the first wireless access point; and transmitting an association request to the first wireless access point based on the first network connection quality and one or more Internet connection quality criteria.

Aspect 2: The method of aspect 1, further comprising: receiving, from at least a second wireless access point, a second message, the second message comprising a second beacon message or second probe response that indicates a second network connection quality associated with one or more metrics associated with Internet access via the second wireless access point, wherein the transmitting the association request to the first wireless access point is further based at least in part on comparing the first network connection quality and the second network connection quality.

Aspect 3: The method of any of aspects 1 through 2, wherein the first message includes a beacon frame transmission that includes an information element that provides the one or more metrics associated with Internet access via the first wireless access point.

Aspect 4: The method of aspect 3, wherein the one or more metrics include an Internet reachability indication indicating whether Internet access is available via the first wireless access point; an Internet link latency indication indicating a latency associated with an Internet connection of the first wireless access point; an available uplink bandwidth of the Internet connection of the first wireless access point; an available downlink bandwidth of the Internet connection of the first wireless access point; or any combination thereof.

Aspect 5: The method of any of aspects 1 through 4, wherein the transmitting comprises: selecting the first wireless access point for an Internet connection based at least in part on the first network connection quality and at least one other network connection quality associated with Internet access via at least one other network entity different than the first wireless access point.

Aspect 6: The method of any of aspects 1 through 5, further comprising: selecting a different network entity other than the first wireless access point for an Internet connection based at least in part on the first network connection quality and at least one other network connection quality associated with Internet access via the different network entity.

Aspect 7: The method of aspect 6, wherein the first wireless access point is associated with a first wireless local area network, and the different network entity is associated with a second wireless local area network or a cellular radio access network.

Aspect 8: The method of any of aspects 1 through 7, wherein the one or more metrics associated with Internet access via the first wireless access point are updated by the first wireless access point according to a first periodicity associated with the first wireless access point.

Aspect 9: The method of any of aspects 1 through 8, wherein the one or more Internet connection quality criteria include one or more of whether the first wireless access point has Internet connectivity, one or more threshold values associated with the one or more metrics associated with Internet access, or any combinations thereof.

Aspect 10: The method of any of aspects 1 through 9, further comprising: monitoring one or more messages of one or more other wireless access points that each indicate an associated network connection quality associated with a respective wireless access point of the one or more other wireless access points; and selecting a second wireless access point for an Internet connection based at least in part a second network connection quality associated with one or more metrics associated with Internet access via the second wireless access point indicating Internet connectivity is available via the second wireless access point.

Aspect 11: The method of any of aspects 1 through 10, further comprising: selecting a network entity associated with a cellular radio access network for Internet access based at least in part on one or more of the one or more metrics associated with Internet access via the first wireless access point being below a threshold value.

Aspect 12: The method of any of aspects 1 through 11, further comprising: receiving, from each of two or more wireless access points, a local area load metric information element and an Internet connection quality information element, the local area load metric information element indicates one or more load metrics of an associated wireless local area network, and an Internet connection quality information element that indicates one or more Internet access metrics; and selecting the first wireless access point from the two or more wireless access points based at least in part on the local area load metric information element and the Internet connection quality information element of each of the two or more wireless access points.

Aspect 13: The method of aspect 12, wherein the local area load metric information element is a quality of service enhanced basic service set load information element that indicates the one or more load metrics of the associated wireless local area network.

Aspect 14: A method for wireless communication at a wireless access point, comprising: transmitting a first message to one or more wireless stations, the first message comprising a beacon message or probe response, and the first message including a network connection quality indication associated with one or more metrics associated with Internet access via the wireless access point; and receiving, from at least a first wireless station of the one or more wireless stations, an association request for Internet access via the wireless access point.

Aspect 15: The method of aspect 14, wherein the first message includes a beacon frame transmission or probe response that includes an information element that provides the one or more metrics associated with Internet access via the wireless access point.

Aspect 16: The method of aspect 15, wherein the one or more metrics include an Internet reachability indication indicating whether Internet access is available via the wireless access point; an Internet link latency indication indicating a latency associated with an Internet connection of the wireless access point; an available uplink bandwidth of the Internet connection of the wireless access point; an available downlink bandwidth of the Internet connection of the wireless access point; or any combinations thereof.

Aspect 17: The method of any of aspects 14 through 16, further comprising: repeating, according to a first periodicity, the transmitting the first message with an updated network connection quality indication associated with one or more updated metrics associated with Internet access via the wireless access point.

Aspect 18: The method of aspect 17, wherein the first periodicity corresponds to a predetermined quantity of beacon frame transmissions.

Aspect 19: The method of any of aspects 14 through 18, further comprising: transmitting, in the first message, a local area load metric information element and an Internet connection quality information element, the local area load metric information element indicating one or more load metrics of a wireless local area network associated with the wireless access point, and the Internet connection quality information element indicating the one or more metrics associated with Internet access via the wireless access point.

Aspect 20: The method of aspect 19, wherein the local area load metric information element is a quality of service enhanced basic service set load information element that indicates the one or more load metrics of the wireless local area network associated with the wireless access point.

Aspect 21: An apparatus for wireless communication at a wireless station, comprising a processor; and memory coupled with the processor and storing instructions executable by the processor to cause the apparatus to perform a method of any of aspects 1 through 13.

Aspect 22: An apparatus for wireless communication at a wireless station, comprising at least one means for performing a method of any of aspects 1 through 13.

Aspect 23: A non-transitory computer-readable medium storing code for wireless communication at a wireless station, the code comprising instructions executable by a processor to perform a method of any of aspects 1 through 13.

Aspect 24: An apparatus for wireless communication at a wireless access point, comprising a processor; and memory coupled with the processor and storing instructions executable by the processor to cause the apparatus to perform a method of any of aspects 14 through 20.

Aspect 25: An apparatus for wireless communication at a wireless access point, comprising at least one means for performing a method of any of aspects 14 through 20.

Aspect 26: A non-transitory computer-readable medium storing code for wireless communication at a wireless access point, the code comprising instructions executable by a processor to perform a method of any of aspects 14 through 20.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system of FIGS. 1 and 2—may include one or more carriers, where each carrier may be a signal made up of multiple sub-carriers (for example, waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication by a wireless station, comprising:
receiving a first message from a first wireless access point, the first message comprising a beacon message or probe response that indicates a first network connection quality associated with one or more metrics associated with Internet access via the first wireless access point; and
transmitting an association request to the first wireless access point based on the first network connection quality and one or more Internet connection quality criteria.

2. The method of claim 1, further comprising:
receiving, from at least a second wireless access point, a second message, the second message comprising a second beacon message or second probe response that indicates a second network connection quality associated with one or more metrics associated with Internet access via the second wireless access point,
wherein the transmitting the association request to the first wireless access point is further based at least in part on comparing the first network connection quality and the second network connection quality.

3. The method of claim 1, wherein the first message includes a beacon frame transmission that includes an information element that provides the one or more metrics associated with Internet access via the first wireless access point.

4. The method of claim 3, wherein the one or more metrics include:
an Internet reachability indication indicating whether Internet access is available via the first wireless access point;
an Internet link latency indication indicating a latency associated with an Internet connection of the first wireless access point;
an available uplink bandwidth of the Internet connection of the first wireless access point;
an available downlink bandwidth of the Internet connection of the first wireless access point; or
any combination thereof.

5. The method of claim 1, wherein the transmitting comprises:
selecting the first wireless access point for an Internet connection based at least in part on the first network connection quality and at least one other network connection quality associated with Internet access via at least one other network entity different than the first wireless access point.

6. The method of claim 1, further comprising:
selecting a different network entity other than the first wireless access point for an Internet connection based at least in part on the first network connection quality and at least one other network connection quality associated with Internet access via the different network entity.

7. The method of claim 6, wherein the first wireless access point is associated with a first wireless local area network, and the different network entity is associated with a second wireless local area network or a cellular radio access network.

8. The method of claim 1, wherein the one or more metrics associated with Internet access via the first wireless access point are updated by the first wireless access point according to a first periodicity associated with the first wireless access point.

9. The method of claim 1, wherein the one or more Internet connection quality criteria include one or more of whether the first wireless access point has Internet connectivity, one or more threshold values associated with the one or more metrics associated with Internet access, or any combination thereof.

10. The method of claim 1, further comprising:
monitoring one or more messages of one or more other wireless access points that each indicate an associated network connection quality associated with a respective wireless access point of the one or more other wireless access points; and
selecting a second wireless access point for an Internet connection based at least in part a second network connection quality associated with one or more metrics associated with Internet access via the second wireless access point indicating Internet connectivity is available via the second wireless access point.

11. The method of claim 1, further comprising:
selecting a network entity associated with a cellular radio access network for Internet access based at least in part on one or more of the one or more metrics associated with Internet access via the first wireless access point being below a threshold value.

12. The method of claim 1, further comprising:
receiving, from each of two or more wireless access points, a local area load metric information element and an Internet connection quality information element, the local area load metric information element indicates one or more load metrics of an associated wireless local area network, and an Internet connection quality information element that indicates one or more Internet access metrics; and
selecting the first wireless access point from the two or more wireless access points based at least in part on the local area load metric information element and the Internet connection quality information element of each of the two or more wireless access points.

13. The method of claim 12, wherein the local area load metric information element is a quality of service enhanced basic service set load information element that indicates the one or more load metrics of the associated wireless local area network.

14. A method for wireless communication at a wireless access point, comprising:
transmitting a first message to one or more wireless stations, the first message comprising a beacon message or probe response, and the first message including a network connection quality indication associated with one or more metrics associated with Internet access via the wireless access point; and
receiving, from at least a first wireless station of the one or more wireless stations, an association request for Internet access via the wireless access point.

15. The method of claim 14, wherein the first message includes a beacon frame transmission or probe response that includes an information element that provides the one or more metrics associated with Internet access via the wireless access point.

16. The method of claim 15, wherein the one or more metrics include:
an Internet reachability indication indicating whether Internet access is available via the wireless access point;
an Internet link latency indication indicating a latency associated with an Internet connection of the wireless access point;
an available uplink bandwidth of the Internet connection of the wireless access point;
an available downlink bandwidth of the Internet connection of the wireless access point; or
any combinations thereof.

17. The method of claim 14, further comprising:
repeating, according to a first periodicity, the transmitting the first message with an updated network connection quality indication associated with one or more updated metrics associated with Internet access via the wireless access point.

18. The method of claim 17, wherein the first periodicity corresponds to a predetermined quantity of beacon frame transmissions.

19. The method of claim 14, further comprising:
transmitting, in the first message, a local area load metric information element and an Internet connection quality information element, the local area load metric information element indicating one or more load metrics of a wireless local area network associated with the wireless access point, and the Internet connection quality information element indicating the one or more metrics associated with Internet access via the wireless access point.

20. The method of claim 19, wherein the local area load metric information element is a quality of service enhanced basic service set load information element that indicates the one or more load metrics of the wireless local area network associated with the wireless access point.

21. An apparatus for wireless communication at a wireless station, comprising:
a processor; and
memory coupled with the processor and storing instructions executable by the processor to cause the apparatus to:
receive a first message from a first wireless access point, the first message comprising a beacon message or probe response that indicates a first network connection quality associated with one or more metrics associated with Internet access via the first wireless access point; and
transmit an association request to the first wireless access point based on the first network connection quality and one or more Internet connection quality criteria.

22. The apparatus of claim 21, wherein the instructions are further executable by the processor to cause the apparatus to:
receive, from at least a second wireless access point, a second message, the second message comprising a second beacon message or second probe response that indicates a second network connection quality associated with one or more metrics associated with Internet access via the second wireless access point,
wherein the transmit the association request to the first wireless access point is further based at least in part on comparing the first network connection quality and the second network connection quality.

23. The apparatus of claim 21, wherein the first message includes a beacon frame transmission that includes an information element that provides the one or more metrics associated with Internet access via the first wireless access point.

24. The apparatus of claim 23, wherein the one or more metrics include:
an Internet reachability indication indicating whether Internet access is available via the first wireless access point;
an Internet link latency indication indicating a latency associated with an Internet connection of the first wireless access point;
an available uplink bandwidth of the Internet connection of the first wireless access point;
an available downlink bandwidth of the Internet connection of the first wireless access point; or
any combination thereof.

25. The apparatus of claim 21, wherein the instructions to transmit are executable by the processor to cause the apparatus to:
select the first wireless access point for an Internet connection based at least in part on the first network connection quality and at least one other network connection quality associated with Internet access via at least one other network entity different than the first wireless access point.

26. The apparatus of claim 21, wherein the one or more Internet connection quality criteria include one or more of whether the first wireless access point has Internet connectivity, one or more threshold values associated with the one or more metrics associated with Internet access, or any combinations thereof.

27. An apparatus for wireless communication at a wireless access point, comprising:
a processor; and
memory coupled with the processor and storing instructions executable by the processor to cause the apparatus to:
transmit a first message to one or more wireless stations, the first message comprising a beacon message or probe response, and the first message including a network connection quality indication associated with one or more metrics associated with Internet access via the wireless access point; and
receive, from at least a first wireless station of the one or more wireless stations, an association request for Internet access via the wireless access point.

28. The apparatus of claim 27, wherein the first message includes a beacon frame transmission or probe response that includes an information element that provides the one or more metrics associated with Internet access via the wireless access point.

29. The apparatus of claim 28, wherein the one or more metrics include:
an Internet reachability indication indicating whether Internet access is available via the wireless access point;
an Internet link latency indication indicating a latency associated with an Internet connection of the wireless access point;
an available uplink bandwidth of the Internet connection of the wireless access point;
an available downlink bandwidth of the Internet connection of the wireless access point; or
any combinations thereof.

30. The apparatus of claim 27, wherein the instructions are further executable by the processor to cause the apparatus to:
repeat, according to a first periodicity, the transmitting the first message with an updated network connection quality indication associated with one or more updated metrics associated with Internet access via the wireless access point.
